(19) United States
(12) Patent Application Publication
(10) Pub. No.: US 2001/0028613 A1
(43) Pub. Date: Oct. 11, 2001

(54) Optical disk, optical disk apparatus, and optical disk tracking error determination method

(76) Inventors: Yutaka Okamoto, Chofu-shi (JP); Hideo Ando, Hino-shi (JP); Chosaku Noda, Kawasaki-shi (JP); Yutaka Kashihara, Fuchu-shi (JP); Hideki Takahashi, Kashiwa-shi (JP); Hiroshi Hasegawa, Yokosuka-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/828,948

(22) Filed: Apr. 10, 2001

(30) Foreign Application Priority Data
Apr. 10, 2000 (JP) 2000-108451

(51) Int. Cl. G11B 7/24

(52) U.S. Cl. 369/44.25; 369/275.3; 369/44.26

(57) ABSTRACT

In this invention, track address information is recorded at a portion different from a recording track along user data by a land pre-pit, wobbled groove interrupt, wobble stop, or a projecting portion formed at a land/groove boundary. With the address information, the track position can be detected at least once per data length of the minimum recording unit. To increase the recording frequency of tracking error detection information, instead of recording the absolute address value of a track, information representing a position in tracks divided into groups is recorded.

### CROSS-REFERENCE TO RELATED APPLICATIONS

This application is based upon and claims the benefit of priority from the prior Japanese Patent Application No. 2000-108451, filed Apr. 10, 2000, the entire contents of which are incorporated herein by reference.

### BACKGROUND OF THE INVENTION

The present invention relates to an optical disk on which data is recorded, an optical disk apparatus for recording data on the optical disk, and an optical disk tracking error determination method of determining a tracking error in recording data on the optical disk.

In recent years, DVD systems are put onto the market to meet a requirement to record an MPEG2 image of two hours or more on one side of a 12-cm diameter optical disk. In this DVD standard, the disk storage capacity is 4.7 GB per side, the track density is 0.74 μm/track, and the line density is 0.267 μm/bit. A DVD based on this standard will be called an existing DVD hereinafter.

Information recorded on an optical disk such as a DVD is played back using an optical head. In the optical head, a light beam emitted from an LD (Laser Diode) is focused to the pit train on a track of an optical disk through an objective lens. The light beam reflected by the optical disk is focused to a photodetector through a focus lens, thus obtaining a playback signal. The playback signal from the photodetector is input to a playback signal processing system and subjected to waveform equalization by an equalizer. Then, the data is decoded by a detector. In the DVD standard, the wavelength of the LD in the optical head is 0.65 μm, and the numerical aperture of the objective lens is 0.6.

There are read-only DVDs and rewritable DVDs, which have different physical formats for data recording.

In a read-only DVD, since data is continuously recorded at the time of mastering, no “data boundaries” are present. In this case, an access unit called a sector is present, which is formed from a sync code (SYNC) used to detect the delimitation of 1-byte data, and is scrambled and then modulated data. The boundary between sectors has no discontinuous point. Both the signal frequency and the phase are constant through the disk perimeter.

To play back the read-only disk, an actuator with an optical head is sought to a track near the track on which target data is recorded. After that, a channel clock is synchronized with the phase of the playback signal using a PLL, byte synchronization is obtained in a SYNC area, and ID information recorded at the start of the sector is read. If an address slightly before the target data is read, playback is started after the position reaches the target data. If the address is too much before or after the target data address, the processing is retried from the seek.

In the read-only disk, all data have already been written at the time of read. In addition, the playback signal has constant frequency and phase through the disk perimeter. Hence, PLL synchronization is easy even without any special pattern for obtaining a gain for phase lead-in, and address information can always be acquired when data can be read. Since read-only disks basically mainly aim at continuously playing back a large amount of data, limitations on the lead-in time are not strict.

Writable DVDs include a DVD-RAM, DVD-R, and DVD-RW. a DVD-RAM can be sufficiently used as a secondary storage device of a computer, like a magnetic disk. The data recording format is different from that of a read-only DVD. In the DVD-RAM, a sector is formed from a 128-byte header area (corresponding to a header field), 2-byte mirror area, and 2,567-byte recording area. In the DVD-RAM, data can be rewritten in units of sectors. Since a discontinuous point is formed at the boundary between sectors, an area serving as a connection is present.

The recording area is formed from a 10- to 11-byte gap area, 20- to 27-byte guard 1 area, 35-byte VFO 3 area, 3-byte pre-synchronous code (PS) area, 2,418-byte data area, 1-byte postamble 3 (PA3) area, 48- to 55-byte guard 2 area, and 24- to 25 byte buffer area.

The contents in the data (user data) area in the recording area match those of a read-only DVD. For this reason, for a portion with written data, address information can also be acquired from the start portion of user data. However, for a portion having no recorded data, the presence of address information is not guaranteed. To acquire address information in such an area, ID information (PID) is written at the start portion (header field) of each sector using an unrewritable pre-pit. The frequency or phase at the ID portion having ID information (PID) does not always match that at the rewritable data portion, and therefore, a synchronous pattern for quickly leading in the PLL is present at the start of each area.

Since the DVD-RAM requires the gap area, ID area, and synchronous pattern for connection, the format efficiency is lower than that of a read-only DVD.

Other types of writable DVDs are a DVD-R and DVD-RW. The number of times of write is one for a DVD-R and about 1,000 for a DVD-RW, which are smaller than 100,000 for a DVD-RAM.

The DVD-R and DVD-RW have been developed aiming at a test write before read-only DVD mastering. Hence, the format for data recording almost matches that of a read-only DVD.

The DVD-R and DVD-RW has no recorded data, and the presence of address information is not guaranteed at the time of use, unlike a read-only DVD. In spite of this, no ID area as in a DVD-RAM is prepared at the start portion of each sector to acquire address information, like a read-only DVD. To acquire address information even in an area having no recorded data, mechanisms called wobbled groove and land pre-pit are used.

As a wobbled groove, a wavy groove for recording data is formed in the radial direction. Data is recorded in synchronism with the amplitude frequency. A land pre-pit is a pre-pit formed at the land portion between grooves at a position synchronous with the amplitude of the wobbled groove. When address information is recorded in the land pre-pit, the address information can be obtained even from an unrecorded area. For example, an address is given in units of ECC blocks each formed from a plurality of (16) sectors.

In the data format of a DVD-RAM, in accessing a sector, since information in the ID area is always read to confirm the address, the reliability is high.

In reading data from the DVD-RAM, even when the light beam spot jumps to another track due to, e.g., some external factor, actual damage can be reduced by discarding erroneously read data and reading the correct data again.

In writing data in the DVD-RAM, however, data may be lost because the erroneously read data may be destroyed, or a mark may be written in the pre-pit header field to make the information undetectable.

In the DVD-RAM, information in the ID area is always read for each sector. Hence, even when the light beam spot jumps to another track during a write, the damage does not extend to two or more sectors. Instead, since the ID area, synchronous pattern, and Gap corresponding to the switching time between the read and the write are necessary, as described above, the format efficiency cannot be increased.

The data format of a DVD-R or DVD-RW is almost the same as that of a read-only DVD, and the format efficiency is higher than that of a DVD-RAM. However, the land pre-pit recording density is considerably lower than the recording density of data or in the ID area. In addition, the address is given not in units of sectors but in units of ECC blocks each formed from 16 sectors.

Information of the land pre-pit can be read either during a write or a read. However, addresses are sparsely recorded. For this reason, when the light beam spot jumps to another track during a data write, the address can hardly be detected, and data is destroyed in a wide range.

### BRIEF SUMMARY OF THE INVENTION

The present invention has been made to solve the above-described problems, and has as its object to provide an optical disk which allows quick tracking error determination in recording data and has a high format efficiency, like a read-only disk.

It is another object of the present invention to provide an optical disk apparatus and optical disk tracking error determination method, which allow quick tracking error determination in recording data on an optical disk having a high format efficiency, like a read-only disk.

According to the present invention, there is provided an optical disk comprising tracks which are formed into a spiral or concentric shape and have recorded data, wherein each of the tracks is formed from a data recording area and a header area where data cannot be directly recorded and has an address recorded in advance at least at a portion in the data recording area.

According to the present invention, there is also provided an optical disk comprising tracks which are formed into a spiral or concentric shape and have data recorded by a recording mark, wherein an address representing a position on the track is recorded by a notch formed on a land side or groove side of a boundary between the adjacent groove and land.

According to the present invention, there is also provided an optical disk apparatus for recording data on an optical disk which has tracks formed into a spiral or concentric shape, each of the tracks being formed from a data recording area and a header area where data cannot be directly recorded and having an address recorded in advance at least at a portion in the data recording area, comprising focus means for focusing light onto the track on the optical disk, detection means for detecting the light from the optical disk, extraction means for, when data is recorded by focusing the light onto a predetermined track on the optical disk by the focus means, extracting address information on the basis of a detection signal from the detection means, and determination means for determining a tracking error on the basis of the address information extracted by the extraction means.

Additional objects and advantages of the present invention will be set forth in the description which follows, and in part will be obvious from the description, or may be learned by practice of the present invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the present invention, and together with the general description given above and the detailed description of the preferred embodiments given below, serve to explain the principles of the present invention.

FIG. 1 is a view showing the schematic structure of an optical disk of the present invention;

FIG. 2 is a view showing the schematic structure of another optical disk of the present invention;

is FIG. 3 is a view showing the schematic structure of still another optical disk of the present invention;

FIG. 4 is a view showing the schematic structure of still another optical disk of the present invention;

FIG. 5 is a view showing the schematic structure of still another optical disk of the present invention;

FIG. 6 is a view showing the schematic structure of still another optical disk of the present invention;

FIG. 7 is a view for explaining the structures of an ECC block and sectors of the optical disk;

FIG. 8 is a view showing the sector format of each sector;

FIG. 9 is an enlarged view schematically showing the structures of a header field (pre-pit header) and the start portion of a sector;

FIG. 10 is an enlarged view schematically showing the structures of the header field (pre-pit header) and the start portion of a sector;

FIG. 11 is a view showing a structure example of land pre-pits;

FIG. 12 is a block diagram showing the schematic arrangement of a land pre-pit signal detection circuit;

FIGS. 13A to 13H are waveform charts of signals at main portions of the land pre-pit signal detection circuit;

FIG. 14 is a block diagram showing the schematic arrangement of another land pre-pit signal detection circuit;

FIG. 15 is a view showing another structure example of the land pre-pits;

FIG. 16 is a view showing still another structure example of the land pre-pits;

FIG. 17 is a view showing still another structure example of the land pre-pits;

FIG. 18 is a view showing still another structure example of the land pre-pits;

FIG. 19 is a view showing still another structure example of the land pre-pits;

FIG. 20 is a view showing still another structure example of the land pre-pits;

FIG. 21 is a view for explaining land pre-pit recording positions;

FIG. 22 is a block diagram showing the schematic arrangement of still another land pre-pit signal detection circuit;

FIGS. 23A to 23F are waveform charts of signals at main portions of the land pre-pit signal detection circuit;

FIGS. 24A to 24H are waveform charts of signals at main portions of the land pre-pit signal detection circuit;

FIG. 25 is a waveform chart showing the signal waveform of a land pre-pit signal;

FIGS. 26A to 26D are views showing a structure in which address information by land pre-pits is recorded in one sector a plurality of number of times (multiple times);

FIG. 27 is a view showing a sector structure for a CLV scheme;

FIGS. 28A to 28D are views for explaining cases wherein a sector is divided by a pre-pit header in the CLV scheme using a pre-pit header;

FIG. 29 is a view for explaining the preformat data of the header field and the states of neighboring grooves and land of an optical disk;

FIG. 30 is a view for explaining the structure of the header field;

FIG. 31 is a block diagram showing the schematic arrangement of an optical disk apparatus according to an embodiment of the present invention;

FIG. 32 is a flow chart for explaining access processing of the optical disk apparatus;

FIG. 33 is a flow chart for explaining seek processing of the optical disk apparatus;

FIG. 34 is a view showing still another structure example of the land pre-pits;

FIGS. 35A to 35C are views showing still other structure examples of the land pre-pits;

FIGS. 36A and 36B are views showing an example in which the same function as in the first embodiment is implemented by partially stopping wobbling in wobbled grooves;

FIG. 37 is a block diagram showing the schematic arrangement of a signal detection circuit;

FIGS. 38A to 38E are waveform charts of signals at main portions of the signal detection circuit;

FIG. 39 is a view for explaining the states of lands and grooves in the optical disk;

FIG. 40 is a view for explaining the states of lands and grooves in the optical disk;

FIG. 41 is a block diagram showing the schematic arrangement of another signal detection circuit;

FIGS. 42A to 42F are waveform charts of signals at main portions of the signal detection circuit; and

FIGS. 43A to 43F are waveform charts of signals at main portions of the signal detection circuit.

### DETAILED DESCRIPTION OF THE INVENTION

The embodiments of the present invention will be described below in detail with reference to the accompanying drawing.

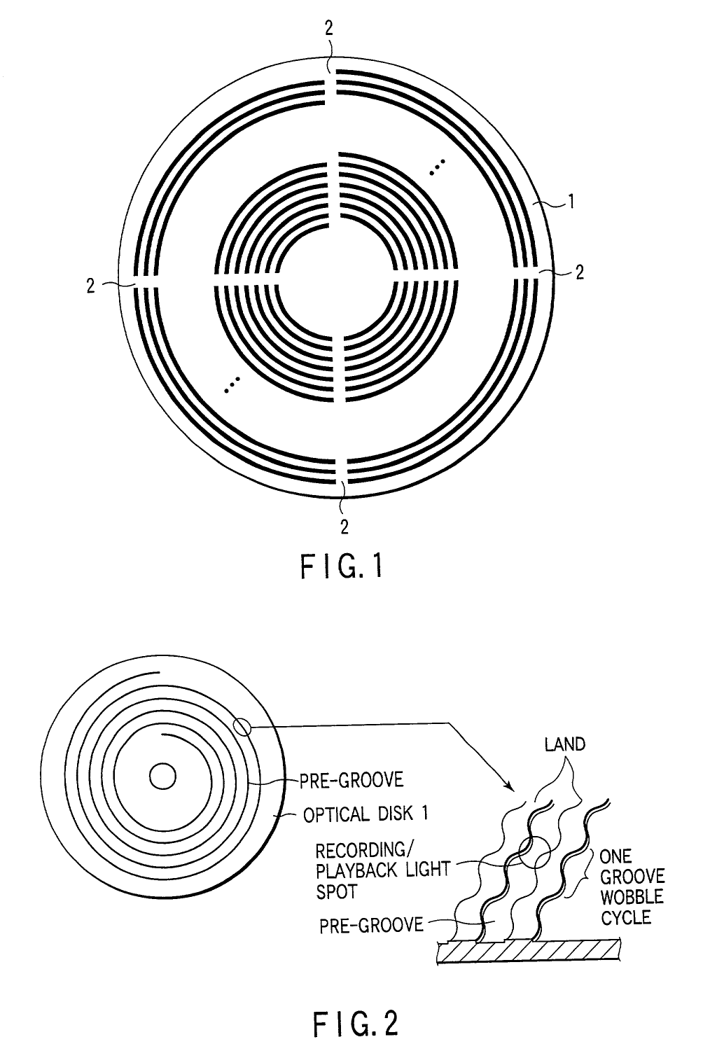

FIG. 1 is a view showing a schematic structure (example of track shape) of an optical disk 1 of the present invention.

This optical disk 1 has spiral grooves and lands formed from the inner to the outer peripheral side. Data is recorded in the grooves as recording tracks. The optical disk 1 has a plurality of sectors each having a recording area where data is recorded in a groove having a predetermined track length. Addresses representing positions on tracks are recorded at adjacent lands of the sectors by pre-pit trains.

The grooves of the optical disk 1 are disconnected at four portions per round in advance. A header field 2 (pre-pit header) formed from a pre-pit (emboss pit) train representing a track address or the like is provided at each disconnected portion in advance.

The grooves of the optical disk 1 are wobbled in advance at a predetermined period for tracking, as shown in FIG. 2. For example, to obtain a signal as a reference for data recording, tracking grooves are wobbled at a predetermined period.

The grooves and lands may be formed not spirally but concentrically.

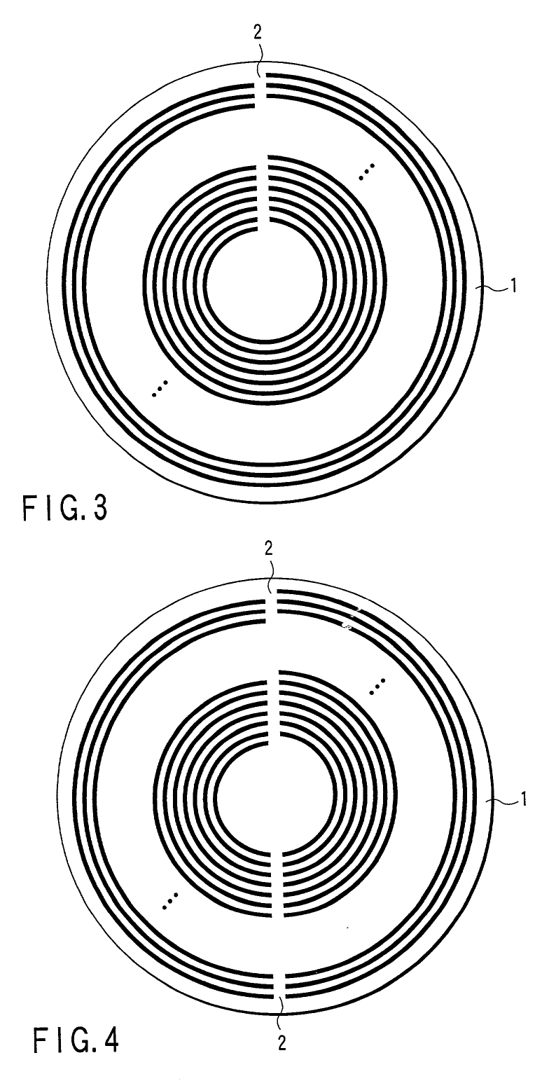

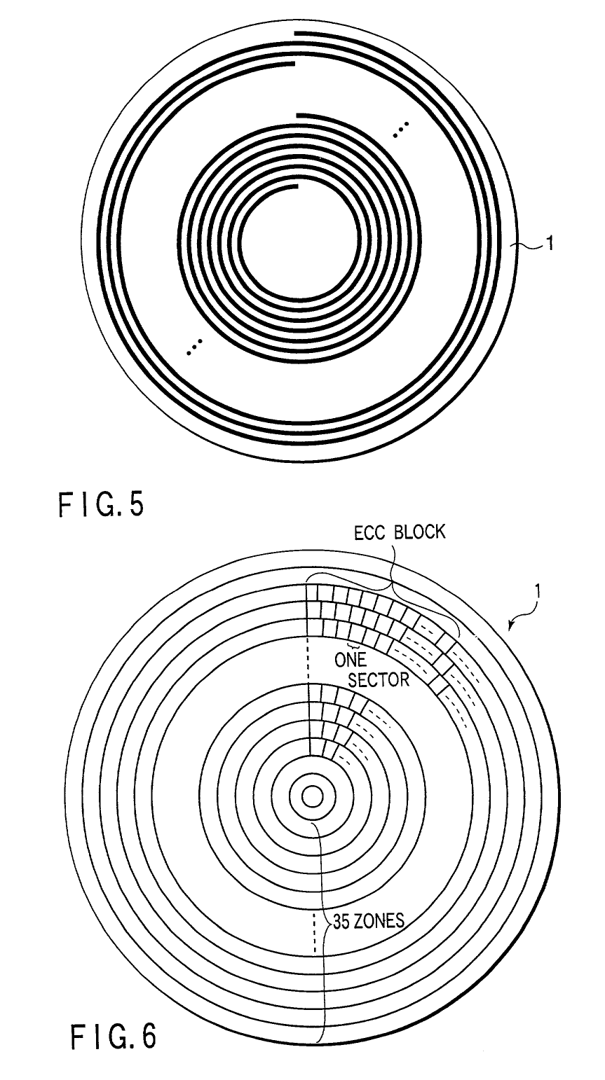

In the optical disk 1, four header fields 2 are prepared per round of tracks. However, one header field 2 may be prepared per round of tracks, as shown FIG. 3. Two header fields 2 may be prepared per round of tracks, as shown FIG. 4. Alternatively, no header field 2 may be prepared per round of tracks, as shown FIG. 5.

In the following embodiment, a case in which four header fields 2 are prepared per round of tracks, as shown in FIG. 1, will be described as a reference.

In this embodiment, data is recorded by a zone CLV (ZCLV) scheme. In this ZCLV scheme, tracks are divided into several zones, and the speed of rotation of the disk is set constant in each zone. The recording frequency is constant through the disk perimeter. Hence, the recording capacities of tracks in a single zone are equal. Referring to FIG. 1, the amounts of information recorded between pre-pit headers are equal. For the descriptive convenience, the following description assumes that the portion between the pre-pit headers is segmented into a predetermined number of sectors depending on the zone. In an applicant of this embodiment, the segmentation unit (=unit of an increase/decrease in capacity for each zone) may be a sync block that has a capacity smaller than that of a sector.

In this embodiment, the term “sector” means a minimum unit that can be recorded, played back, and rewritten. In the DVD format, 16 sectors form one ECC block. In the ECC block structure of a DVD, parity bits are distributed to the sectors and recorded. Hence, although a binary data sequence can be rewritten in units of sectors, the parity suffers inconsistency when only one sector is rewritten. To prevent this, significant data is rewritten only in units of ECC blocks. For this reason, the ECC block can also be regarded as a rewrite unit. In this embodiment, however, the “sector” as an access unit to a binary data sequence will be called a minimum recordable unit.

The optical disk 1 has, e.g., 35 zones, as shown in FIG. 6. The speed of rotation (reference speed) of the optical disk 1 and the number of sectors per track change between the zones.

Each zone has a plurality of (1,568) tracks in the radial direction.

In each zone, the speed of rotation (speed) becomes low, and the number of sectors per track increases from the inner to the outer peripheral side of the optical disk 1.

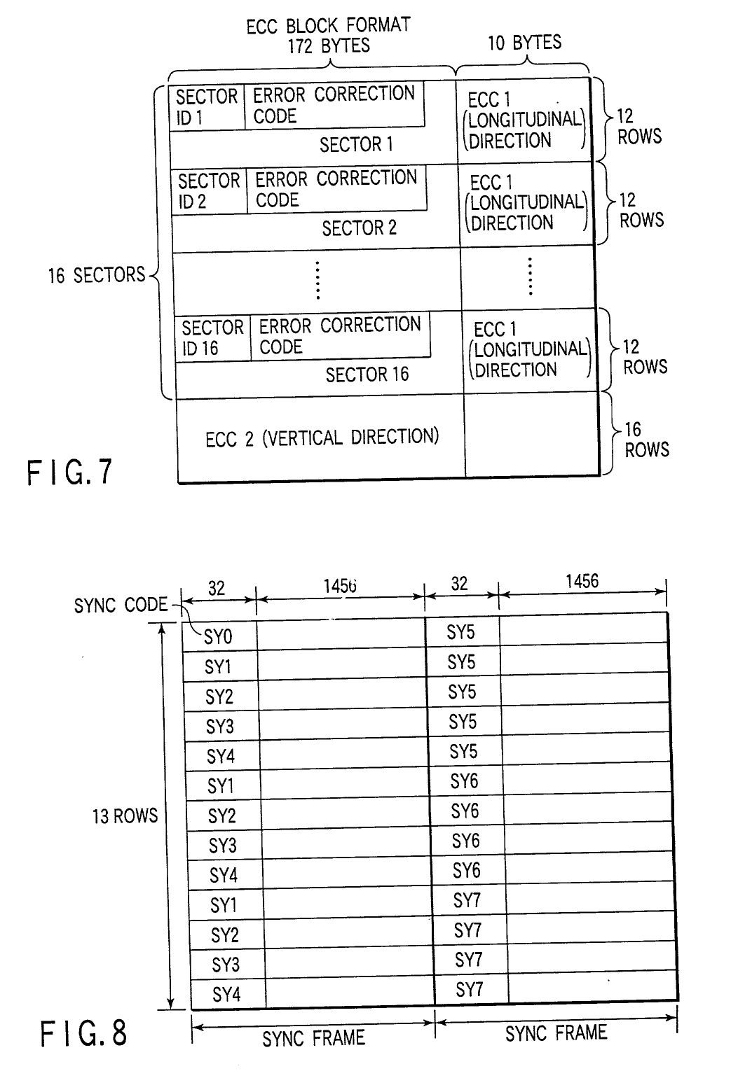

In each track of each zone, data is recorded in units of ECC (Error Correction Code) block data (e.g., 38,688 bytes) as a data recording unit, as shown in FIG. 7.

An ECC block is formed from 16 sectors in which 2-Kbyte data is recorded. Together with 4-byte (32 bits) sector IDs (identification data) 1 to 16 as address data and 2-byte error detection codes (IED: ID error detection code), main data (longitudinal ECCs (Error Correction Codes) 1 and a vertical ECC 2 as error correction codes added to sector data and used to play back data recorded in the ECC block) is recorded. The ECCs 1 and 2 are error correction codes which are added to data as redundancy words for preventing data playback from becoming impossible due to a defect in the optical disk 1.

Each sector is formed from 172-byte, 12-row data. A 10-byte longitudinal ECC 1 is added to each row (line), and a 182-byte vertical ECC 2 corresponding to one row is also added. An error correction circuit 92 (to be described later) executes error correction processing for each line using the longitudinal ECC 1 and error correction processing for each column using the vertical ECC 2.

When the ECC block is recorded on the optical disk 1, a sync code (2 bytes: 32 channel bits) used for byte synchronization in playing back data is added in units of predetermined data amounts (in units of predetermined data lengths, e.g., 91 bytes: 1,456 channel bits) of each sector.

As shown in FIG. 8, each sector is formed from 26 frames, i.e., the 0th to 25th frames (frame=91 bytes; 1,456 channel bits). A sync code (frame sync signal) added to each frame is formed from a specific code (1 byte: 16 channel bits) for specifying a frame number, and a common code (1 byte: 16 channel bits) common to the frames.

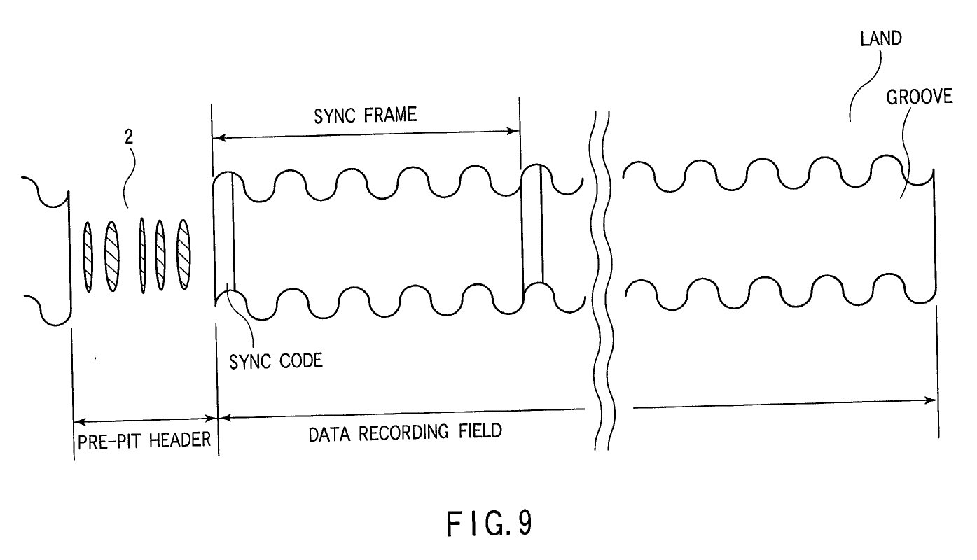

FIG. 8 is a view showing the structure of a physical sector of a DVD. The sector is formed for 16 sync frames each starting from a 32-channel-bit sync code, so the entire size is 38,688 channel bits. FIG. 9 is an enlarged view schematically showing the structures of the header field (pre-pit header) 2 and the start portion of a sector.

In this embodiment, four pre-pit headers 2 are formed per round. When the user data capacity of a sector in a large-capacity optical disk is 2 Kbytes, the number of sectors on one track is more than 4, and not all sectors have pre-pit headers at their starts. A groove in which data is recorded is wobbled at a frequency low enough to easily separate the data as compared to recorded data. More specifically, the frequency is almost as low as several to several ten fractions the repeating period of the sync frames. One sector is formed from 26 sync frames, as shown in FIG. 8.

In the following description, assume that the wobble period is 1 /W the sync frame period. In this case, wobbles of 26*W cycles are contained in one sector. For the sake of simplicity, FIG. 9 shows a sync frame that starts immediately after the pre-pit header 2. In an actual rewritable disk, to change the read-to-write switching time or the write position in order to prevent medium destruction, a GAP, PLL lead-in pattern, and the like are present.

In this embodiment, land pre-pits 3 as shown in FIG. 10 are formed at land portions between the grooves, where data is recorded, in synchronism with the wobble period.

If the land pre-pits 3 can be laid out in synchronism with the convex portions of all wobbles, as shown in FIG. 11, information of 26*W bits can be recorded in one sector. In the current DVD standard, a physical sector number is represented by 24 bits. Hence, these pieces of information can easily represent a track number which is smaller than the sector number by one or two orders of magnitudes. These pieces of information suffice although, normally, a sync code is added to the start to synchronize information delimitation or a parity for detecting an error is added.

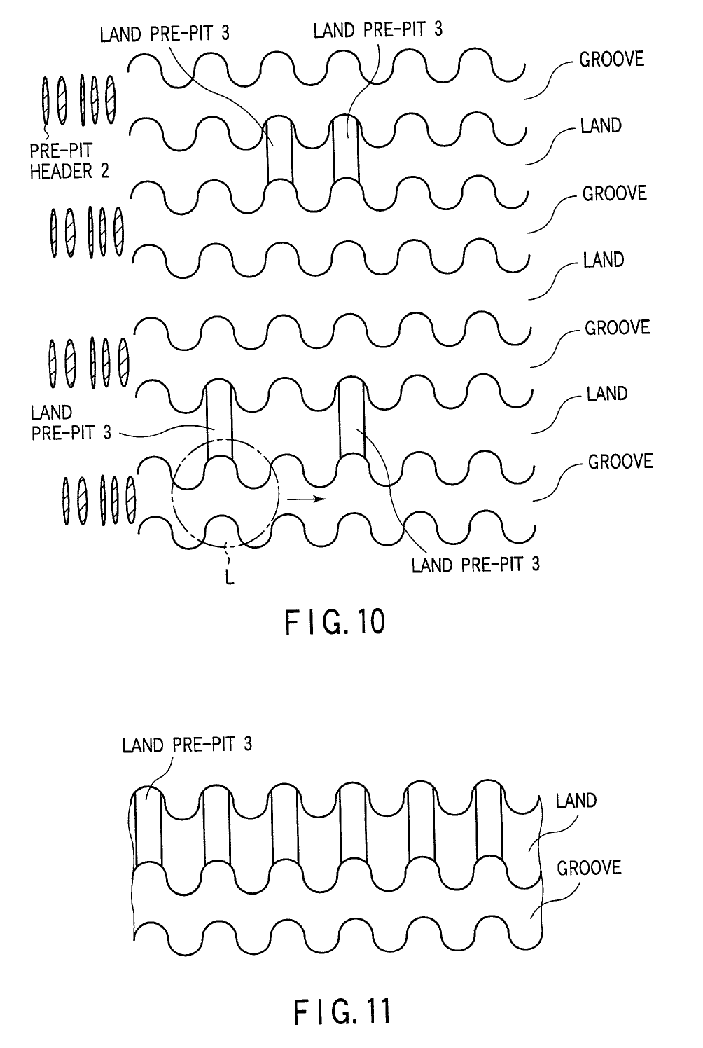

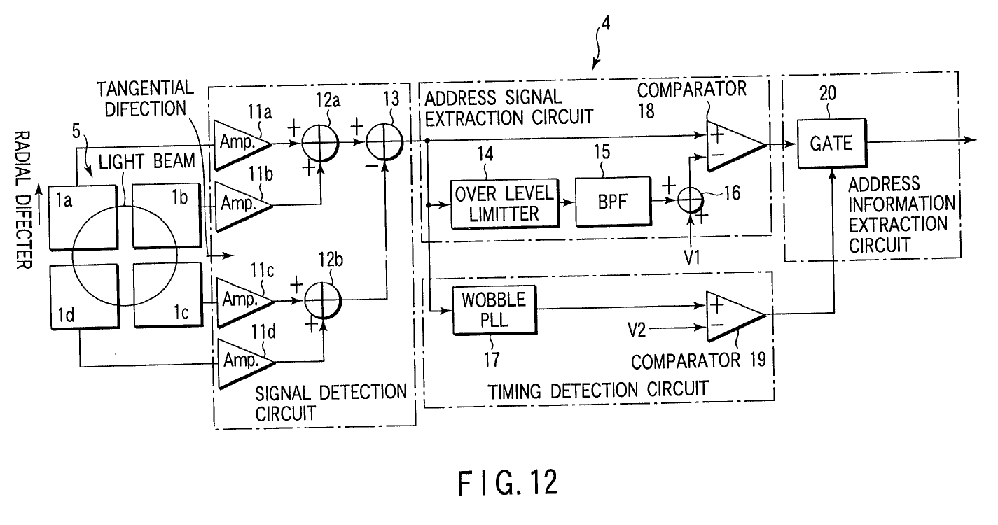

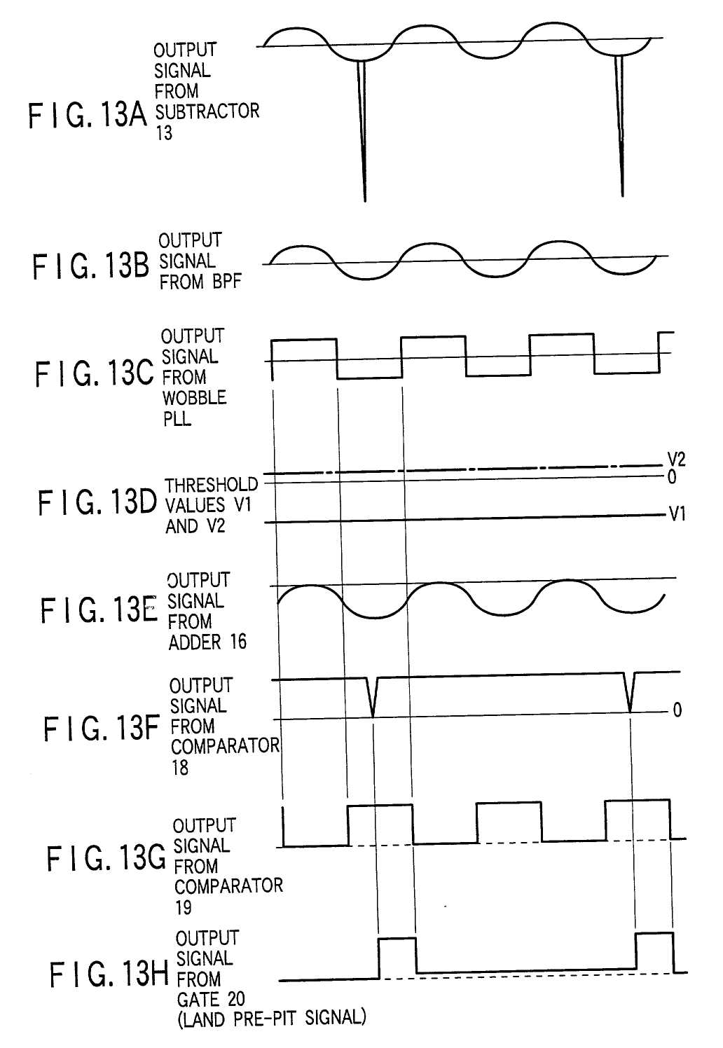

A land pre-pit signal detection circuit 4 for detecting a land pre-pit signal corresponding to the land pre-pit 3 will be described next with reference to FIGS. 12 and 13A to 13H.

When a sector on a predetermined groove is being irradiated with a light beam from an optical head (optical pickup 42 to be described later), the land pre-pit signal detection circuit 4 detects a land pre-pit signal corresponding to the land pre-pit 3 of a land adjacent to that groove on the basis of detection signals (Ia, Ib, Ic, and Id) from a photodetector 5 divided into four parts in the optical head as shown in FIG. 12.

As shown in FIG. 12, the land pre-pit signal detection circuit 4 comprises a signal detection circuit formed from amplifiers 11a, 11b, 11c, and 11d for amplifying the detection signals (Ia, Ib, Ic, and Id) from the photodetector 5, an adder 12a for adding the signals from the amplifiers 11a and 11b, an adder 12b for adding the signals from the amplifiers 11c and 11d, and a subtractor 13 for subtracting the signal from the adder 12b from the signal from the adder 12a, an address signal extraction circuit formed from an over level limiter 14 for removing signal components of a predetermined level or more from the signal from the subtractor 13, a bandpass filter 15 for outputting only signal components in a predetermined frequency band from the signal from the over level limiter 14, an adder 16 for adding a predetermined threshold value V1 to the signal from the bandpass filter 15, and a comparator 18 for comparing the signal from the subtractor 13 with the signal from the adder 16 and outputting only a signal based on the land pre-pit 3, a timing detection circuit formed from a wobble PLL 17 for generating a wobble clock synchronized with a wobble from the signal from the subtractor 13, and a comparator 19 for comparing the signal from the wobble PLL 17 with a predetermined threshold value V2 and outputting a gate open signal corresponding to a convex portion of a wobble, and an address information extraction circuit formed from a gate 20 for outputting a land pre-pit signal in accordance with the signal based on the land pre-pit 3, which is output from the comparator 18, and the gate open signal from the comparator 19.

When the lowermost groove shown in FIG. 10 is scanned with a light beam L, a signal shown in FIG. 13A is output from the subtractor 13. That is, when a signal [(Ia+Ib)−(Ic+Id)] is observed using the detection signals (Ia, Ib, Ic, and Id) from the photodetector 5, the waveform shown in FIG. 13A is observed.

When signal components of a predetermined level or more are removed by the over level limiter 14 from the signal from the subtractor 13, and only signal components in a predetermined frequency band are output through the bandpass filter 15, a wobble signal corresponding to the concave and convex portions of a wobble is extracted, as shown in FIG. 13B.

By adding the predetermined threshold value V1 shown in FIG. 13D to the wobble signal by the adder 16, a signal obtained by reducing the level of the whole wobble signal is output, as shown in FIG. 13E.

The signal from the subtractor 13, which is shown in FIG. 13A, is compared with the signal from the adder 16, which is shown in FIG. 13E, and the signal from the subtractor 13 is subtracted from the signal from the adder 16 whereby the comparator 18 outputs only a signal based on the land pre-pit 3, as shown in FIG. 13F.

A wobble clock shown in FIG. 13C is generated on the basis of the signal from the subtractor 13 by the wobble PLL 17 in synchronism with the wobble. The comparator 19 compares the wobble clock with the predetermined threshold value V2 shown in FIG. 13D and outputs a gate open signal corresponding to the concave portions of the wobble, as shown in FIG. 13G.

Thus, the gate 20 outputs a land pre-pit signal as shown in FIG. 3H in accordance with the signal based on the land pre-pit 3, which is output from the comparator 18, and the gate open signal from the comparator 19.

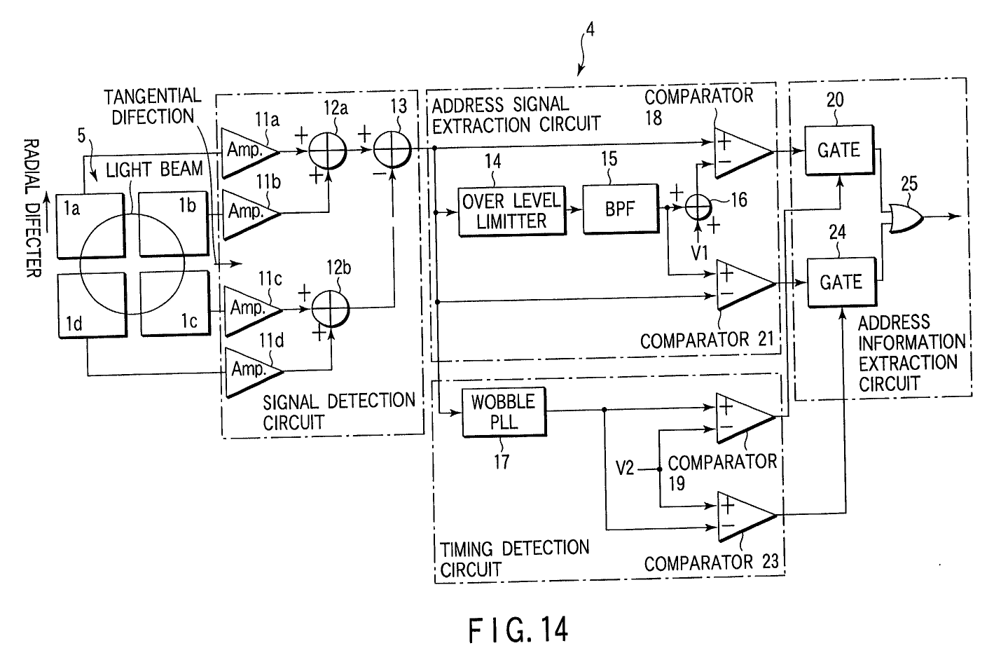

When the land pre-pit signal detection circuit 4 is modified as shown in FIG. 14, a land pre-pit at a concave portion of a wobble can also be detected, so the concave portion can also have information. In this case, the recordable information amount can be doubled as compared to the case wherein information can be recorded only at the convex portions.

This arrangement can be implemented by adding, in the arrangement shown in FIG. 13, a comparator 21 for outputting only a land pre-pit signal corresponding to a concave portion of a wobble to the address signal extraction circuit, a comparator 23 for outputting a gate open signal corresponding to the concave portion of the wobble to the timing detection circuit, a gate 24 for outputting a land pre-pit signal in accordance with a signal based on the land pre-pit 3, which is output from the comparator 21, and the gate open signal from the comparator 23, and an OR circuit 25 for outputting the OR of the outputs from the gates 20 and 24 to the address information extraction circuit.

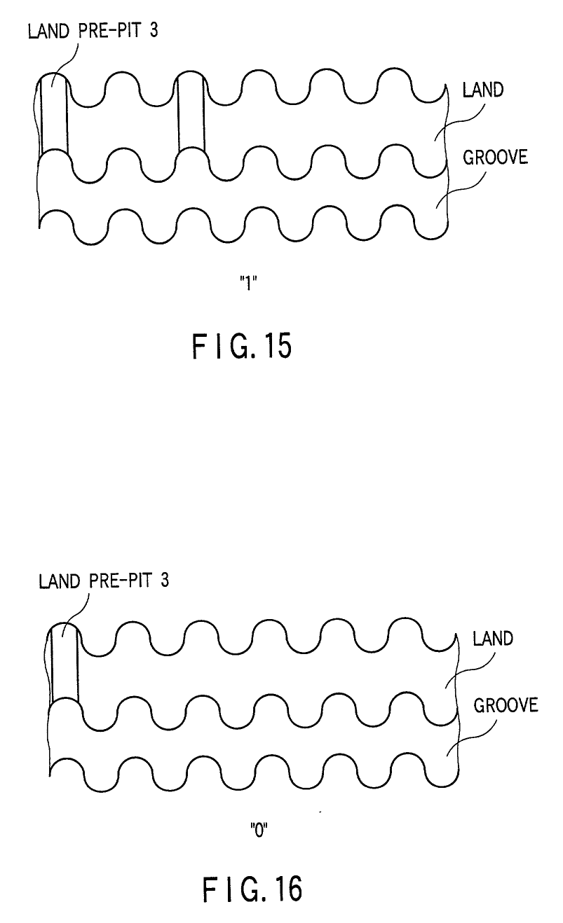

When 1-bit information is recorded in one land pre-pit 3, the information amount is calculated in the above way. To improve the reliability, a code may be formed by a plurality of land pre-pits 3 to represent 1-bit information, as shown in FIGS. 15 and 16. For example, “1” is represented when two, first and third land pre-pits 3 are detected within five bits, as shown in FIG. 15, and “0” is represented when only the first land pre-pit 3 is detected within five bits, as shown in FIG. 16.

The number of land pre-pits 3 that form a code may be equal to the number of land pre-pits 3 that can be recorded in one sync frame.

For one set of wobbled groove and land pre-pit 3, or when the influence of the land pre-pit 3 on the opposite side of a wobbled groove can be neglected at any position, all the data recordable positions can be used, as described above.

However, when the track density increases, the influence of the land pre-pit 3 on an adjacent track cannot be neglected. In this case, some measure must be taken to prevent any interference between the recording positions of the land pre-pits 3.

In the ZCLV recording scheme, since the phases of wobbles between adjacent tracks are almost constant, the adjacent tracks only need to selectively use odd- and even-numbered positions.

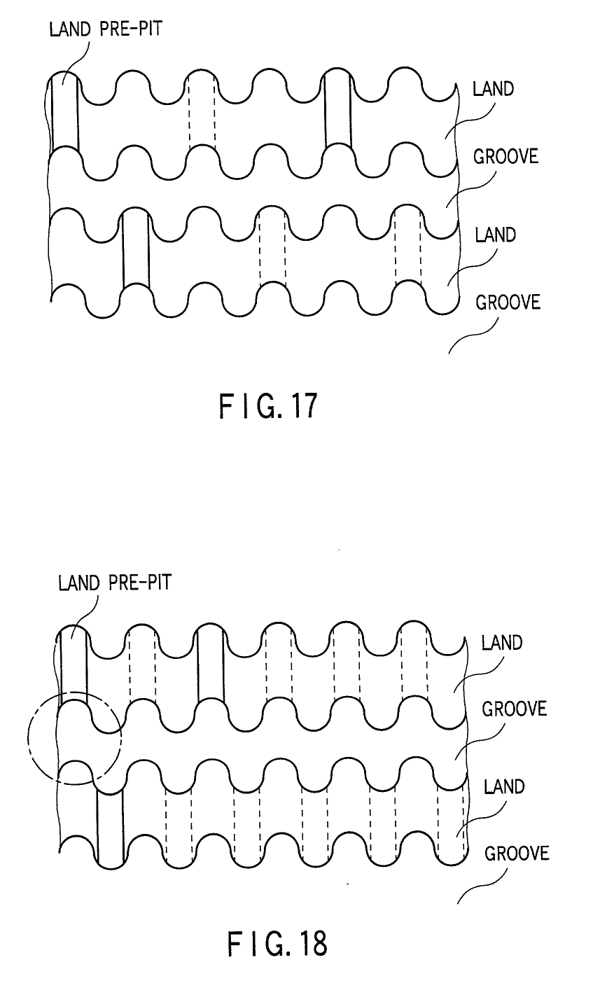

FIG. 17 shows a case wherein the land pre-pits 3 are recorded at the convex portions of wobbles, and adjacent tracks alternately use even- and odd-numbered convex portions. A position where the land pre-pit 3 is indicated by the broken lines represents a land pre-pit recordable position without any land pre-pit.

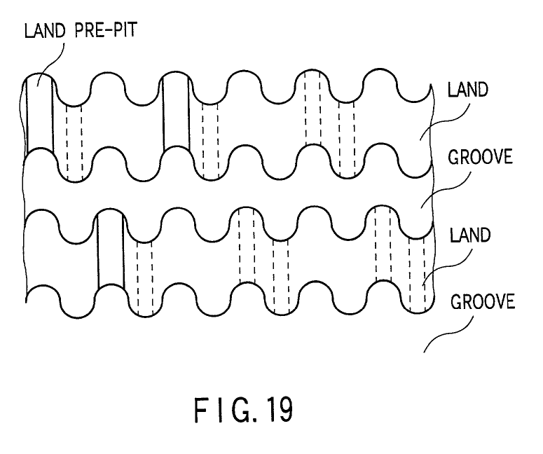

FIGS. 18 and 19 show cases wherein the land pre-pits 3 are recorded at both the convex and concave portions of wobbles. Referring to FIG. 18, adjacent tracks alternately use the convex and concave portions. Referring to FIG. 19, adjacent tracks alternately use even-numbered convex and concave portions and odd-numbered convex and concave portions.

FIG. 20 shows an example wherein a code is formed by a plurality of land pre-pits 3 to represent 1-bit information. The positions of codes by even-numbered land pre-pits 3 and the positions of codes by odd-numbered land pre-pits 3 are selectively used. When the number of land pre-pits 3 that form a code equals the number of land pre-pits 3 that can be recorded in one sync frame, even-numbered sync frames and odd-numbered sync frames are selectively used.

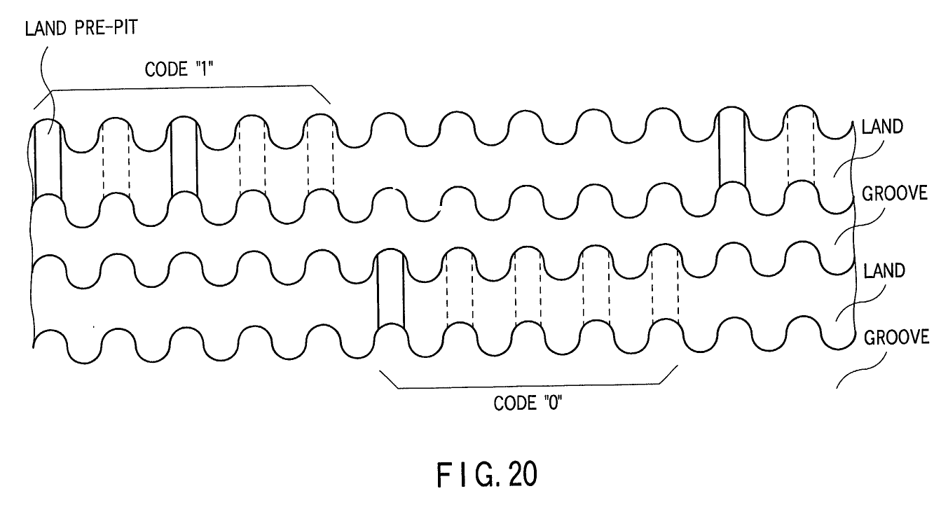

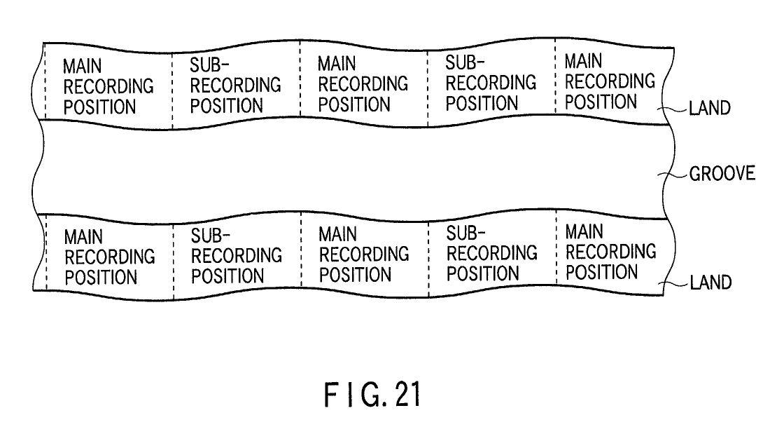

In the CLV scheme, since the capacity per track changes between adjacent tracks (i.e., the number of bits recorded in one track changes), the wobbling phase is not constant. Hence, in the method of selectively using the even- and odd-numbered positions between adjacent tracks, the positions of the land pre-pits 3 cannot be shifted. In this case, the recording positions of the land pre-pits 3 are divided into main recording positions and subrecording positions, as shown in FIG. 21, thereby preventing the influence of land pre-pits 3 between the adjacent tracks. Instead of fixing even- or odd-numbered positions depending on the track, even- or odd-numbered positions at which pre-pit positions do not overlap are selected to record land pre-pits.

In this case, if the position replacing unit is one bit, and no bit is detected at the time of playback, it cannot be determined whether the undetected bit represents information “0” or has shifted to the other of the even- and odd-numbered positions. To avoid this, the scheme of forming a code by a plurality of land pre-pits 3 to represent 1-bit information is selected. The coded set of land pre-pits 3 that form a code is replaced between an even-numbered position and an odd-numbered position. A code in which no land pre-pit 3 is detected is not used. This allows detection of a positional shift.

For the sake of simplicity, in the above-described coding scheme of forming a code using a plurality of land pre-pits 3, 1-bit data is mapped to a plurality of land pre-pits 3. However, a more general (n,m) modulation scheme of converting n-bit information into m bit sequences can also be used without any problem.

In the ZCLV recording scheme, since the wobbling phase is almost constant between adjacent tracks, the adjacent tracks only need selectively use the odd- and even-numbered positions. In other words, the land pre-pits 3 on both sides of a wobbled groove can be separately read. For this reason, as long as the read direction is correctly recognized, the land pre-pits 3 on either side can be read, or the information on both sides may be read. The circuit arrangement for this operation is the same as that of the land pre-pit signal detection circuit 4 shown in FIG. 14.

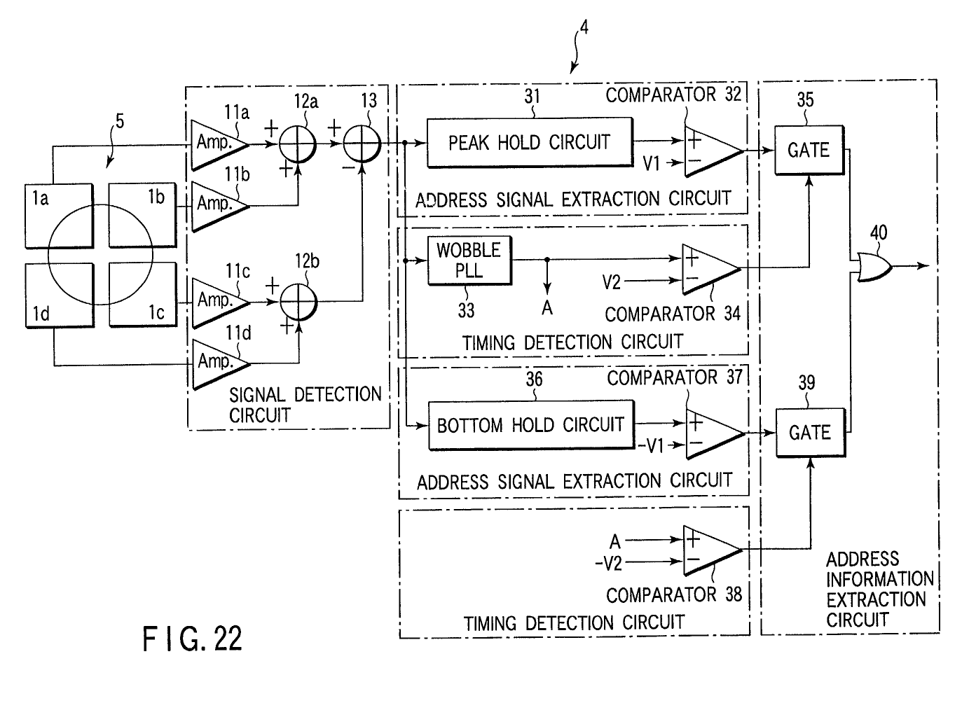

FIG. 22 is a block diagram showing the schematic arrangement of another land pre-pit signal detection circuit 4 for separately reading the land pre-pits 3 on both sides of a track. In the ZCLV recording scheme, when the land pre-pits 3 are in the state shown in FIG. 18, a signal from the land pre-pit 3 on the inner peripheral side is detected by holding the peak, comparing it with a threshold value, and gating the signal by a PLL signal synchronized with the wobble. A signal from the land pre-pit 3 on the outer peripheral side is detected by holding the bottom, comparing it with a threshold value, and gating the signal by a PLL signal synchronized with the wobble.

As shown in FIG. 22, the land pre-pit signal detection circuit 4 comprises a signal detection circuit formed from the amplifiers 11a, 11b, 11c, and 11d for amplifying the detection signals (Ia, Ib, Ic, and Id) from the photodetector 5, the adder 12a for adding the signals from the amplifiers 11a and 11b, the adder 12b for adding the signals from the amplifiers 11c and 11d, and the subtractor 13 for subtracting the signal from the adder 12b from the signal from the adder 12a, address signal extraction circuits respectively formed from a peak hold circuit 31 for peak-holding the signal from the subtractor 13, and a comparator 32 for comparing the output from the peak hold circuit 31 with the threshold value V1, and a bottom hold circuit 36 for bottom-holding the signal from the subtractor 13, and a comparator 37 for comparing the output from the bottom hold circuit 36 with the threshold value −V1, timing detection circuits respectively formed from a wobble PLL 33 for generating a wobble clock synchronized with a wobble from the signal from the subtractor 13, and a comparator 34 for comparing the signal from the wobble PLL 33 with the threshold value V2 and outputting a gate open signal corresponding to the concave portion of the wobble, and a comparator 38 for comparing the signal from the wobble PLL 33 with the threshold value −V2 and outputting a gate open signal corresponding to a convex portion of a wobble, and an address information extraction circuit formed from a gate 35 for outputting a land pre-pit signal in accordance with the signal based on the inner-peripheral-side land pre-pit 3, which is output from the comparator 32, and the gate open signal from the comparator 34, a gate 39 for outputting a land pre-pit signal in accordance with the signal based on the outer-peripheral-side land pre-pit 3, which is output from the comparator 37, and the gate open signal from the comparator 38, and an OR circuit 40 for ORing the land pre-pit signal from the gate 35 and the land pre-pit signal from the gate 39.

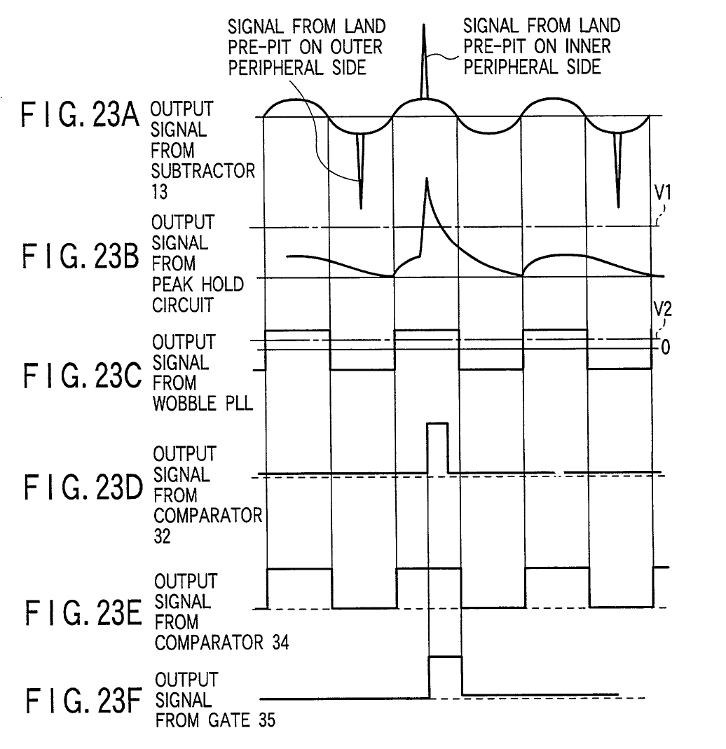

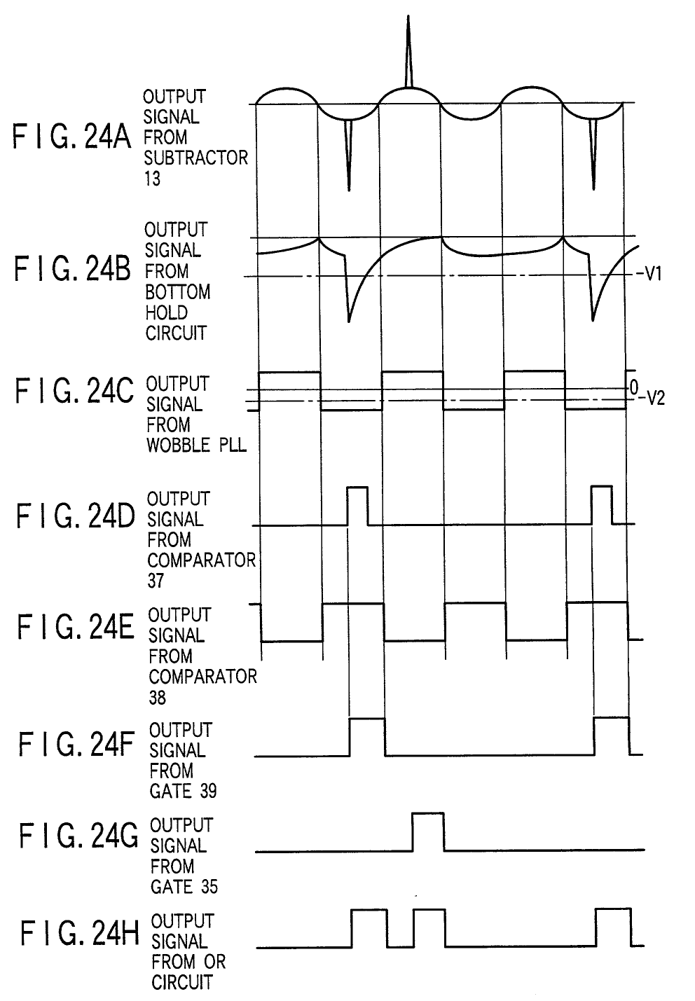

When the groove shown in FIG. 18 is scanned with the light beam L, a signal shown in FIGS. 23A and 24A is output from the subtractor 13. That is, when a signal [(Ia+Ib)−(Ic+Id)] is observed using the detection signals (Ia, Ib, Ic, and Id) from the photodetector 5, the waveform shown in FIGS. 23A and 24A is observed.

When the signal from the subtractor 13 is peak-held by the peak hold circuit 31, a peak hold signal as shown in FIG. 23B is obtained. When a signal as shown in FIG. 23D, which is obtained by comparing the peak hold signal with the threshold value V1, is gated by a signal as shown in FIG. 23E, which is synchronized with a wobble PLL as shown in FIG. 23C, the gate 35 outputs a land pre-pit signal as shown in FIG. 23F, which is based on the land pre-pit 3 on the inner peripheral side.

When the signal from the subtractor 13 is bottom-held by the bottom hold circuit 36, a bottom hold signal as shown in FIG. 24B is obtained. When a signal as shown in FIG. 24D, which is obtained by comparing the bottom hold signal with the threshold value −V1, is gated by a signal as shown in FIG. 24E, which is synchronized (inverted) with a wobble PLL as shown in FIG. 24C, the gate 39 outputs a land pre-pit signal as shown in FIG. 24F, which is based on the land pre-pit 3 on the outer peripheral side.

As a result, the OR circuit 40 ORs the land pre-pit signal as shown in FIG. 24F, which is output from the gate 39, and the land pre-pit signal as shown in FIG. 24G, which is output from the gate 35, and outputs a land pre-pit signal as shown in FIG. 24H, which is based on the land pre-pits 3 on the inner and outer peripheral sides.

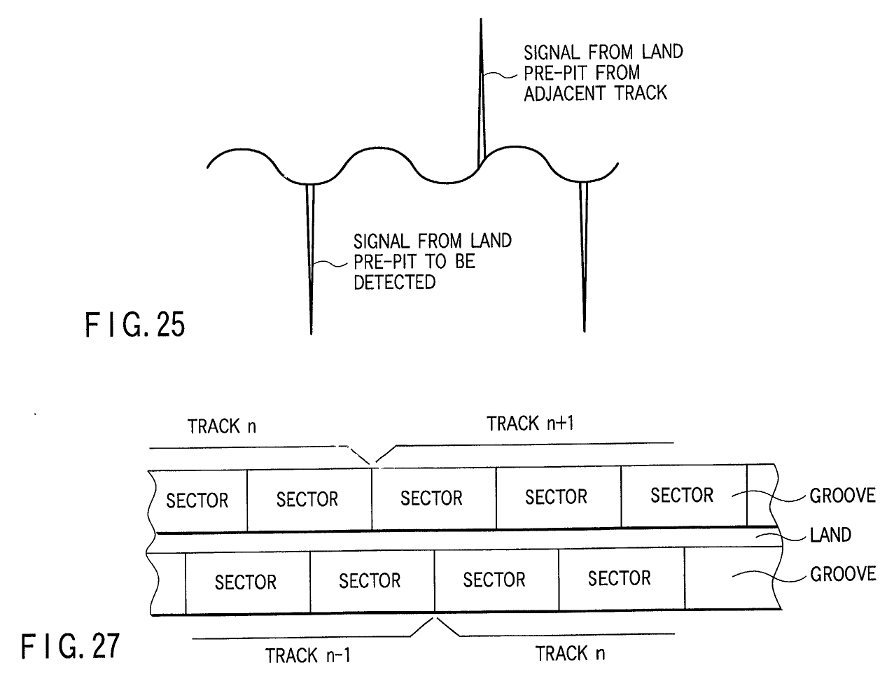

In the CLV recording scheme, since the wobble phase is not constant between adjacent tracks, a signal as shown in FIG. 25 is obtained. In this case, the land pre-pit signal of an adjacent track can be eliminated using only bottom hold.

How to use the extracted land pre-pit signal based on the land pre-pits 3 on the inner and outer peripheral sides will be described.

The land pre-pits 3 are recorded at the main recording positions. If land pre-pits 3 are recorded on the inner peripheral side and cannot be recorded at the main recording positions on the outer peripheral side, they are recorded at the subrecording positions on the outer peripheral side.

When the land pre-pit recording positions on the inner and outer peripheral sides are simultaneously monitored, a portion where a land pre-pit 3 is recorded at a subrecording position on the outer peripheral side can be known, and the reliability in playing back the land pre-pit signal improves.

Even when a land pre-pit signal recorded at a subrecording position on the outer peripheral side cannot be detected due to dust or flaw on the optical disk surface, the data can be corrected by predicting the detection signal on the basis of the position of a land pre-pit recorded on the inner peripheral side, and the data can be corrected.

When pre-pit headers 2 are not added in units of sectors, as in the above embodiment, a tracking error that takes place between these pre-pit headers 2 is preferably detected as soon as possible by the land pre-pit 3 of this embodiment. A large effect can be obtained when the number of land pre-pits 3 that must be read to detect a tracking error is as small as possible. However, when the number of land pre-pits 3 is small, the number of recordable track numbers also becomes small. In such a case, instead of recording all track numbers on the optical disk 1 by absolute values, the tracks may be divided into several zones, and relative positions in each zone may be recorded, as shown in FIG. 6.

When the number of land pre-pits 3 which must be read to detect a tracking error is smaller than the number of land pre-pits 3 which can be recorded in one sector, the range of erase error due to a tracking error can be minimized.

In addition, when the number of land pre-pits 3 which must be read to detect a tracking error is reduced to an integer fraction of the number of land pre-pits 3 which can be recorded in one sector, and the start position of the train of the land pre-pits 3 which must be read to detect a tracking error is aligned with the start position of the sector, the detection efficiency improves.

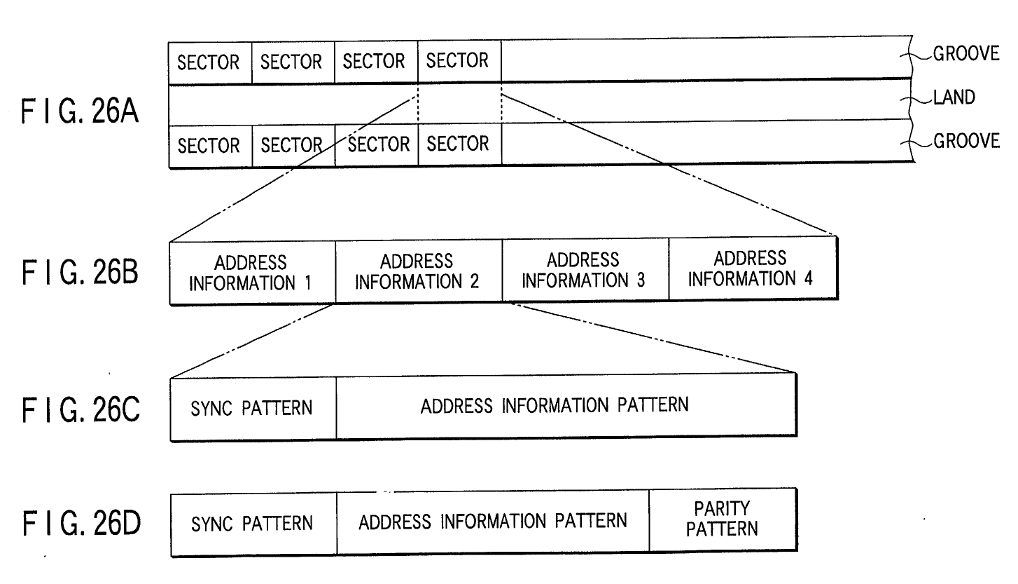

FIGS. 26A to 26D are views showing a structure in which address information by the land pre-pits 3 which must be read to detect a tracking error is recorded in one sector a plurality of number of times (multiple times). In the example shown in FIG. 26B, the address information is recorded four times as pieces of address information 1 to 4, though their contents are the same. A piece of address information starts with a sync code (sync pattern) for synchronizing information delimitation and then contains address information, as shown in FIG. 26C. A parity pattern for detecting an error may be added, as shown in FIG. 26D. The address information may contain one or both of a track number and a sector number.

In the ZCLV scheme, the sector start positions in a zone are aligned in the radial direction, though not in the CLV scheme. Even in this case, the minimum rewrite unit is the sector. Hence, as shown in FIG. 27, the angle of rotation from the start of the first sector to the end of the last sector, which are assigned a certain track number, is set to be smaller than 360° such that another track number is always read in case of a tracking error.

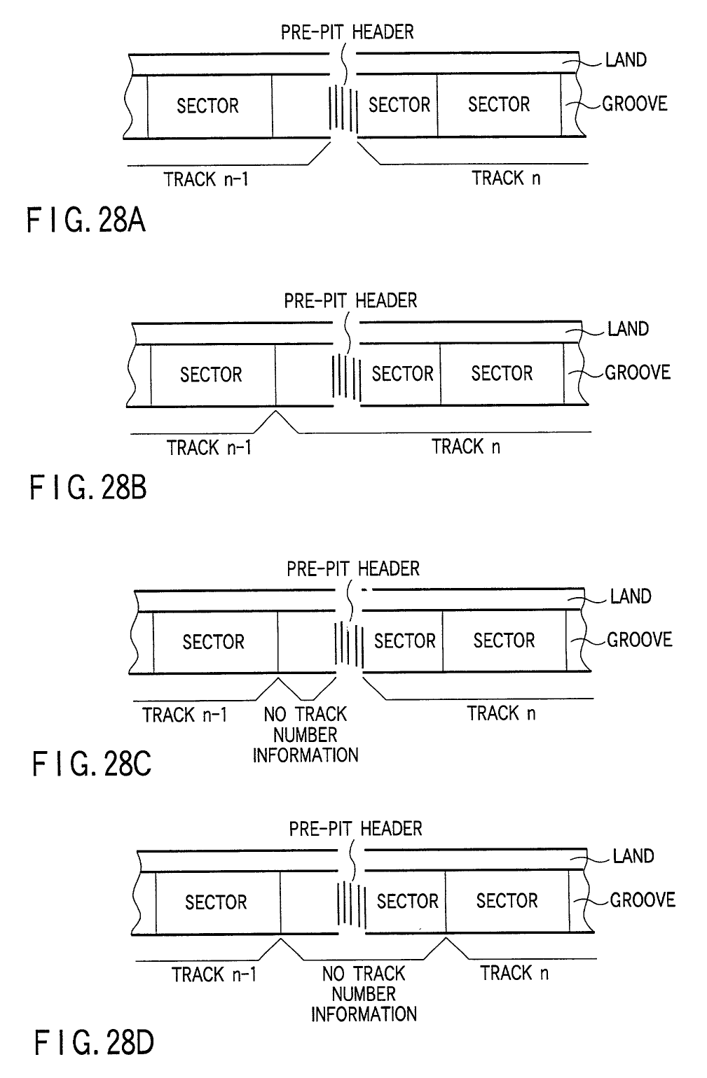

In the CLV scheme using the pre-pit header 2, the minimum write unit may be divided by the pre-pit header 2, as shown in FIGS. 28A to 28D. In this case, any attempt to write in this position is interrupted by the pre-pit header 2.

Hence, the following measures can be taken.

1) For track address information by the land pre-pit 3, the track number changes before and after the pre-pit header 2 (FIG. 28A).

2) The track number is changed from the write unit having the pre-pit header 2 inserted (FIG. 28B).

3) The information by the land pre-pit 3 is not written in the divided minimum write unit portion before the pre-pit header 2, and the function is executed by the immediately succeeding pre-pit header 2 (FIG. 28C).

4) The track information by the land pre-pit 3 is not written in the write unit having the pre-pit header 2 inserted (FIG. 28D).

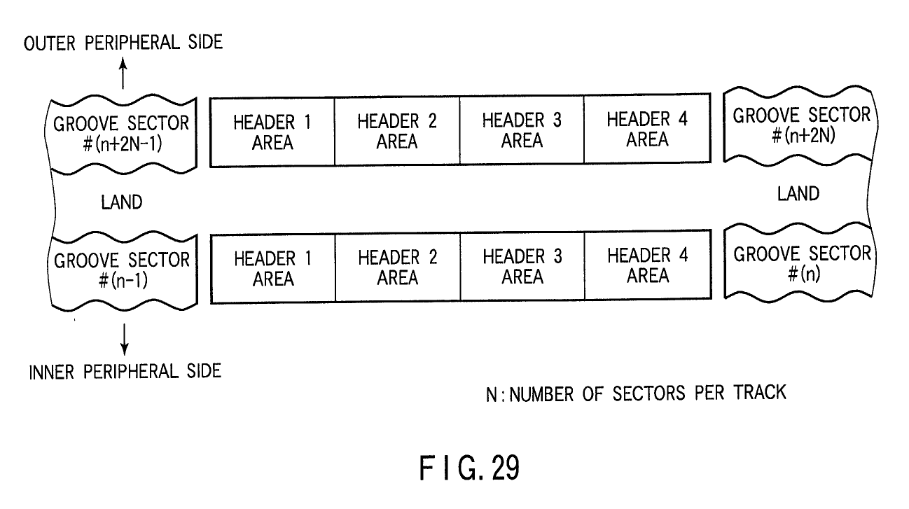

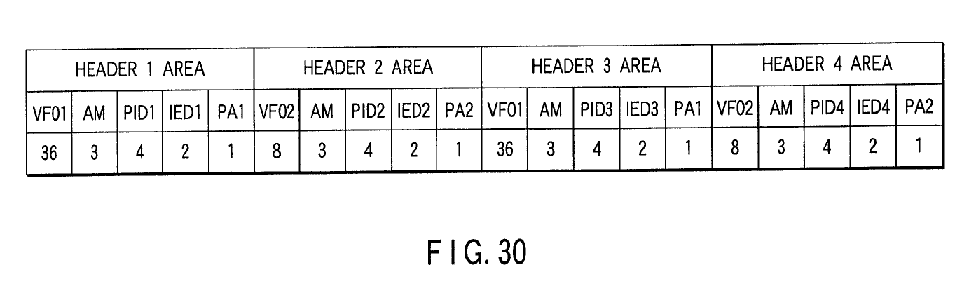

The header field 2 is formed at the time of groove formation. As shown in FIGS. 29 and 30, the header field 2 is formed from four header areas, i.e., header 1 area, header 2 area, header 3 area, and header 4 area having a plurality of pits, and preformatted with respect to a groove, as shown in FIGS. 29 and 30. The pit center is present on a single line at the center of the amplitude of the groove.

Each of the header 1 area to header 4 area is constituted by 46 or 18 bytes: 36- or 8-byte sync code field VFO (Variable Frequency Oscillator), 3-byte address mark AM (Address Mark), 4-byte address field PID (Position IDentifier), 2-byte error detection code IED (ID Error Detection code), and 1-byte postamble PA (PostAmbles).

Each of the header 1 area and header 3 area has a 36-byte sync code field VFO1, and each of the header 2 area and header 4 area has an 8-byte sync code field VFO2.

The sync code fields VFO1 and VFO2 are areas used for PLL lead-in. The sync code field VFO1 records a channel bit sequence “00010001 . . . ” corresponding to “36” bytes (576 channel bits) (records a pattern with a predetermined interval). The sync code field VFO2 records a channel bit sequence “00010001 . . . ” corresponding to “8” bytes (128 channel bits). The sync code field VFO1 has a so-called 4T continuous pattern.

The address mark AM is a “3”-byte sync code representing the start position of a sector address. For the bytes of this address mark AM, a special pattern “000100010000000000000100010001000000000000010001” that does not appear in the data field is used.

The address fields PID1 to PID4 are areas in each of which a sector number as a 4-byte address is recorded. The sector number is a physical sector number as a physical address representing a physical position on a track of the optical disk 1. This physical sector number is recorded in the mastering process and therefore cannot be rewritten.

Each of the address fields PID (1 to 4) is formed from 1-byte (8-bit) sector information and 3-byte sector number (physical sector number as a physical address representing a physical position on a track). The sector information is formed from a 2-bit reserve area, 2-bit physical ID number area, 3-bit sector type area, and 1-bit layer number area.

The physical ID number represents the ordinal number of the four overwrite cycles in one header field 51 and, e.g., “1” for PID1.

In the sector type area, codes representing the first and last sectors in the track are recorded.

The error detection code IED is an error detection code for a sector address (including an ID number), with which the presence/absence of an error in the read PID can be detected.

The postamble PA contains state information necessary for demodulation and also has a function of adjusting the polarity such that the header field 51 ends with a space.

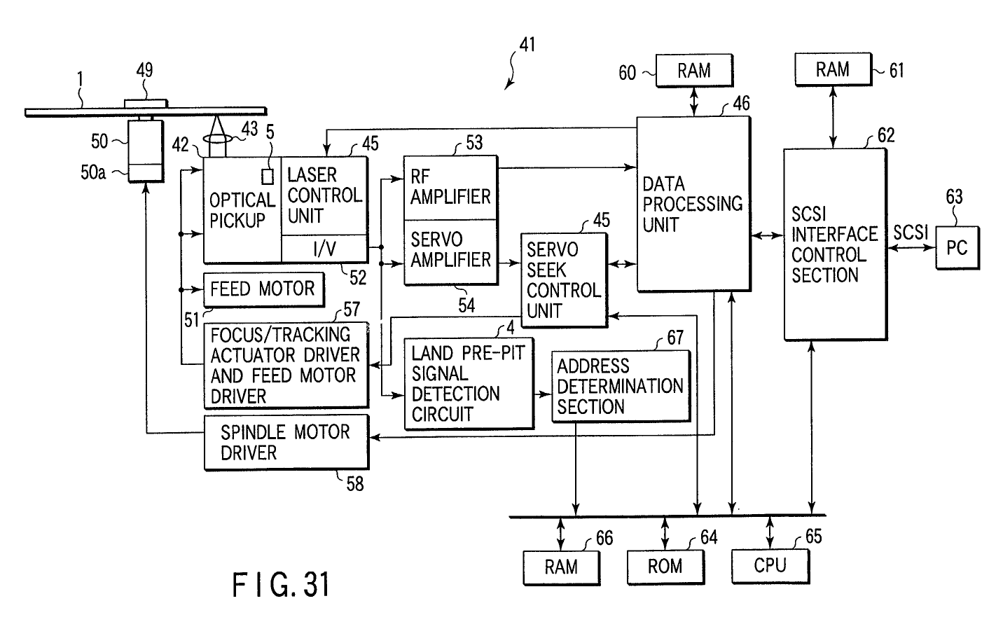

An optical disk apparatus according to an embodiment of the present invention will be described next with reference to FIG. 31.

An optical disk apparatus 41 records data on the above-described optical disk 1 and plays back the data from the optical disk 1.

This optical disk apparatus 41 records data on the optical disk 1 or plays back the data recorded on the optical disk 1 by rotating the optical disk 1 having a plurality of zones each formed from a plurality of tracks while changing the speed of rotation for each zone.

The optical pickup 42 arranged under the optical disk 1 has an objective lens 43. In the optical pickup 42, a semiconductor laser unit (not shown) is arranged in correspondence with the objective lens 43, which is biased by a laser control unit 45 to emit a light beam having a corresponding wavelength. When the semiconductor laser unit is biased, the light beam corresponding to the optical disk 1 is directed to the corresponding objective lens 43 and focused onto the optical disk 1 through the objective lens 43. The focused light beam writes or plays back data in or from the optical disk 1.

Settings for the laser control unit 45 are done by a data processing unit 46. The settings change between the playback mode for obtaining a playback signal, the recording mode for recording data, and the erase mode for erasing data. The light beam has power of different levels for the three, playback, recording, and erase modes. The semiconductor laser unit is biased by the laser control unit 45 to emit a light beam with power corresponding to each mode.

The loaded optical disk 1 is rotatably held on a spindle motor 50 by a stamper 49 and rotated by the spindle motor 50.

The optical pickup 42 incorporates the photodetector 5 for detecting a light beam. The photodetector 5 detects the light beam reflected by the is optical disk 1 and returned through the objective lens 43. A detection signal (current signal) from the photodetector 5 is converted into a voltage signal by a current/voltage converter (I/V) 52. This signal is supplied to a reference amplifier (RF amplifier) 53, servo amplifier 54, and the above-described land pre-pit signal detection circuit 4. The reference amplifier 53 outputs, to the data processing unit 46, a tracking error signal for playing back data from the header field 2 and a sum signal for playing back data from each sector. A servo signal (track error signal and focus signal) from the servo amplifier 54 is output to a servo seek control unit 55.

To optically detect a focus shift amount, for example, the following methods can be used.

[Astigmatic Method] An optical element (not shown) for generating astigmatism is inserted in the detection optical path of a laser beam reflected by the light reflecting film or light reflecting recording film of the optical disk 1 so as to detect a change in shape of the laser beam with which the photodetector is irradiated. The photodetection region is diagonally divided into four parts. For the detection signal obtained from each detection region, the difference between diagonal sums is calculated in the DVD servo seek control unit 55, thereby obtaining a focus error detection signal (focus signal).

[Knife Edge Method] A knife edge for partially asymmetrically shielding the laser beam reflected by the optical disk 1 is used. The photodetection region is divided into two parts. The difference between the detection signals obtained from the detection regions is calculated, thereby obtaining a focus error detection signal.

The above astigmatic method or knife edge method is normally employed.

The optical disk 1 has spiral or concentric tracks and information is recorded on the tracks. A focused light spot is traced along the tracks to play back or record/erase information. To stably trace the focused light spot along the tracks, the relative positional shift between a track and the focused light spot must be optically detected.

To detect a tracking error, the following methods are generally used.

[Differential Phase Detection Method] A change in intensity distribution of the laser beam on the photodetector 5, which is reflected by the light reflecting film or light reflecting recording film of the optical disk 1, is detected. The photodetection region is diagonally divided into four parts. For the detection signal obtained from each detection region, the difference between diagonal sums is calculated in the DVD servo seek control unit 55, thereby obtaining a track error detection signal (tracking signal).

[Push-Pull Method] A change in intensity distribution of the laser beam on the photodetector 5, which is reflected by the optical disk 1, is detected. The photodetection region is divided into two parts. The difference between the detection signals obtained from the detection regions is calculated, thereby obtaining a track error detection signal.

[Twin-Spot Method] The light beam is divided into a plurality of wavefronts by arranging, e.g., a diffraction element in the light sending system between the semiconductor laser element and the optical disk 1, and a change in reflected light amount of list-order diffraction light with which the optical disk 1 is irradiated is detected. Independently of the photodetection region used to detect a playback signal, photodetection regions used to individually detect the reflected light amount of +1st-order diffraction light and that of −1st-order diffraction light are arranged. The difference between the detection signals is calculated, thereby obtaining a track error signal.

In the DVD mode, the focus signal, tracking signal, and feed signal are sent from the DVD servo seek control unit 55 to a focus/tracking actuator driver and feed motor driver 57. The objective lens 43 is focus-servo-controlled and tracking-servo-controlled by the driver 57.

A bias signal is supplied from the driver 57 to a feed motor 51 in accordance with an access signal so that the feed of the optical pickup 42 is controlled.

The servo seek control unit 55 is controlled by the data processing unit 46. For example, the data processing unit 46 supplies an access signal to the servo seek control unit 55 to generate a feed signal.

A spindle motor driver 58 and tray motor driver 59 are controlled by control signals from the data processing unit 46 so that the spindle motor 50 is biased and rotated at a predetermined speed of rotation.

The land pre-pit signal detection circuit 4 detects a land pre-pit signal corresponding to the land pre-pit 3 on a land adjacent to a sector on a predetermined groove currently irradiated with the light beam by the optical pickup 42 on the basis of the detection signals from the photodetector 5.

The land pre-pit signal from the land pre-pit signal detection circuit 4 is output to an address determination section 67.

The address determination section 67 determines an address on the basis of the land pre-pit signal supplied from the land pre-pit signal detection circuit 4. For example, a counter for counting the number of wobbles after determination of the header field 2 is prepared, the land pre-pit signal is extracted in units of sectors or predetermined bits on the basis of the count value of the counter, and the track number and sector number as addresses are determined in accordance with the land pre-pit signal extracted in units of sectors or predetermined bits. The address determined by the address determination section 67 is supplied to a CPU 65 (to be described later). Determination of “0” or “1” based on the land pre-pit signal may be done on the basis of either the count value of the counter or the appearance state of the land pre-pit signal.

The playback signal corresponding to data in the header field 2, which is supplied to the data processing unit 46, is supplied to the CPU 65 (to be described later).

The CPU 65 determines the track number and sector number as the addresses of the header field 2 in accordance with the land pre-pit signal from the data processing unit 46, and on the basis of the determined track number and sector number as addresses and the track number and sector number supplied from the address determination section 67 as addresses, performs comparison with a sector number as an address to be accessed (in which data is to be recorded or from which data is to be played back).

While recording data or playing back recorded data, the CPU 65 determines tracking error on the basis of the address.

For the playback signal corresponding to sector data, which is supplied to the data processing unit 46, necessary data is stored in a RAM 60, the playback signal is processed by the data processing unit 46 and supplied to a SCSI interface control section 62 having a RAM 61 serving as a buffer, and the playback processing signal is supplied to another device, e.g., a personal computer (host apparatus, host device, or PC) 63 through the SCSI 62.

The sections shown in FIG. 31 are controlled by the CPU 65 in accordance with a procedure stored in a ROM 64. A RAM 66 is used as a memory for the CPU 65.

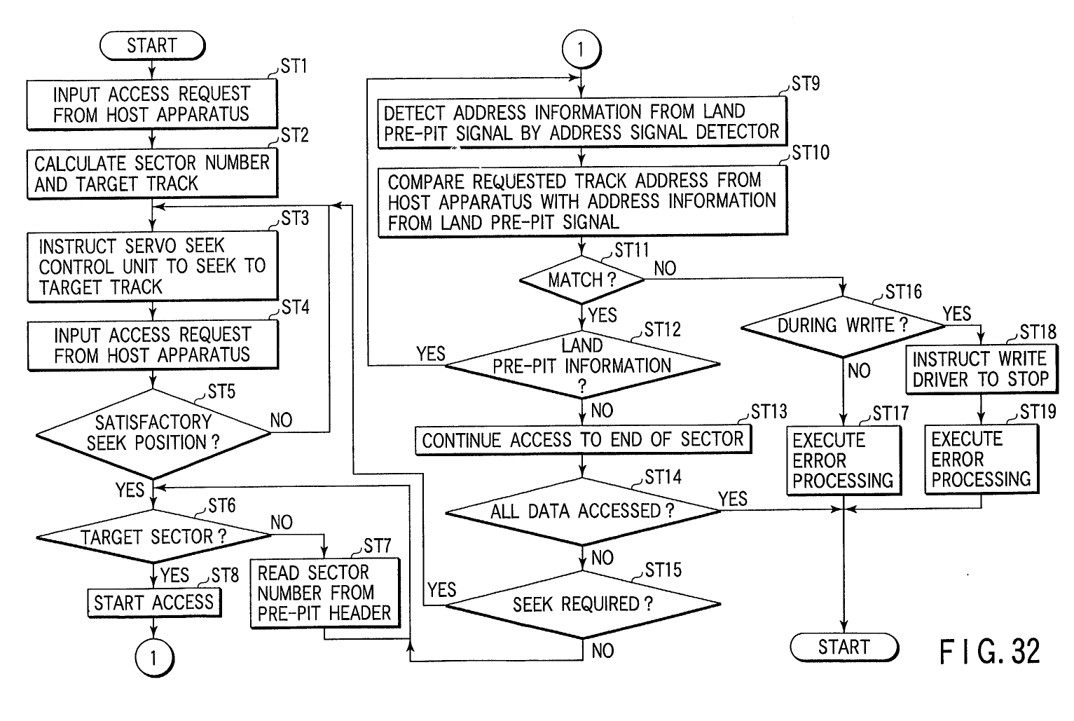

Access processing in the above-described optical disk apparatus 41 having the land pre-pit signal detection circuit 4 and address determination section 67 will be described next with reference to the flow chart shown in FIG. 32.

Assume that the optical disk 1 shown in FIG. 1 is used, and the access to data is sequentially done from the sector following the header field 2.

An access request for a logic data block based on the interface specifications is supplied from the PC 63 to the CPU 65 through the SCSI interface control section 62 (ST1). The CPU 65 calculates the sector number and target track to be accessed from the logic data block number to be accessed (ST2). The CPU 65 instructs the servo seek control unit 55 to seek to the target track (ST3).

On the basis of this instruction, the servo seek control unit 55 outputs an access signal to the driver 57, so that a bias signal from the driver 57 is supplied to the feed motor 51 to move the optical pickup 42 toward the target track.

The spindle motor driver 58 is controlled by a control signal from the data processing unit 46. The spindle motor 50 is biased and its rotation is controlled to a predetermined speed of rotation corresponding to the target zone.

When the light beam from the optical pickup 42 comes onto the predetermined track, a playback RF difference signal as a tracking error signal from the RF amplifier 53 is supplied to the data processing unit 46. The data processing unit 46 supplies to the CPU 65 a playback signal corresponding to the data in the header field 2.

On the basis of the playback signal from the data processing unit 46, the CPU 65 determines the track number and sector number as the addresses of the header field 2 (ST4), and compares the determined track number with the target track number to be accessed, thereby determining whether the seek position of the optical pickup 42 is at the target track (determining whether the seek position is appropriate) (ST5). If NO in step ST5, the flow returns to step ST3. That is, if fine adjustment is necessary, the servo seek control unit 55 is repeatedly instructed to seek.

If YES in step ST5, the CPU 65 compares the determined sector number with the target sector number, thereby determining whether the laser beam irradiation position of the optical pickup 42 is at the target sector (ST6). If NO in step ST6, the CPU 65 determines the sector number on the basis of a playback signal corresponding to data in the next header field 2 on the same track (ST7), and the flow returns to step ST6.

If YES in step ST6, the CPU 65 starts accessing the data (ST8). For example, a recording pit is written in the groove based on the recording data, or a playback signal is read on the basis of the recording pit recorded in the groove.

When the access to the sector on the predetermined track starts, the address determination section 67 determines the address on the basis of the land pre-pit signal from the land pre-pit signal detection circuit 4 and sends the determined address to the CPU 65 (ST9).

The CPU 65 compares a track address calculated from the request from the PC 63 with the track address which is determined by the address determination section 67 from the land pre-pit signal (ST10).

If it is determined by this comparison that the addresses match (ST11), the CPU 65 further determines whether address information by the land pre-pit 3 is recorded in the same sector (ST12). If YES in step ST12, the flow returns to step ST9 to repeat the above check.

If NO in step ST12, the access is continued to the end of the corresponding sector (ST13), and it is determined whether all data instructed by the PC 63 are accessed (ST14).

If YES in step ST14, the CPU 65 ends the access processing.

If NO in step ST14, the CPU 65 determines whether seek is necessary (ST15). If YES in step ST15, the flow returns to step ST3. If NO in step ST15, the flow returns to step ST6.

If it is determined by the comparison in step ST10 that the addresses do not match (ST11), the CPU 65 determines whether the access processing is a data write (ST16). If YES in step ST16, the CPU 65 immediately causes the laser control unit 45 to stop writing, and executes error processing of transmitting an error status to the PC 63 (ST17 and ST18).

If it is determined that the access processing is read operation (ST16), the CPU 65 interrupts the read and executes error processing of transmitting an error status to the PC 63 or retry processing (return to step ST3) (ST19).

In the above example, the address which is determined by the address determination section 67 from the land pre-pit signal is used to detect a tracking error in the data access. However, the present invention is not limited to this. The address which is determined by the address determination section 67 from the land pre-pit signal may be used for seek control for the light beam from the optical pickup 42.

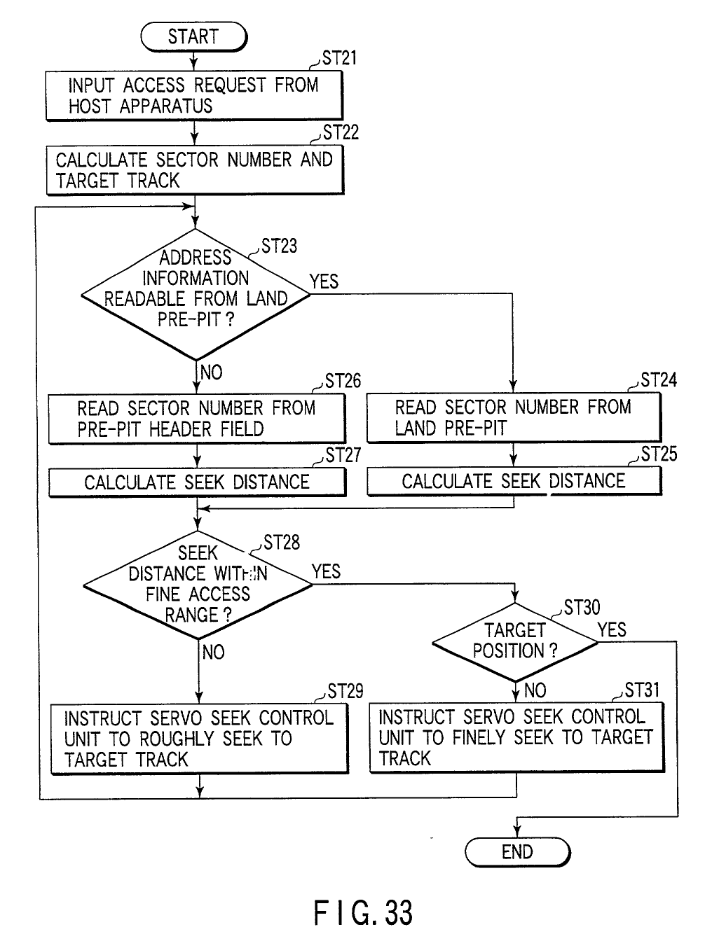

The seek processing will be described with reference to the flow chart shown in FIG. 33.

Assume that the optical disk 1 shown in FIG. 1 is used, and the seek is performed on the basis of a sector number which is determined by the address determination section 67 from the land pre-pit signal and the sector number from the header field 2.

An access request for a logic data block based on the interface specifications is supplied from the PC 63 to the CPU 65 through the SCSI interface control section 62 (ST21). The CPU 65 calculates the sector number and target track to be accessed from the logic data block number to be accessed (ST22).

The CPU 65 determines whether address data based on the land pre-pit signal, which is output from the address determination section 67, can be read (ST23). If YES in step ST23, the CPU 65 determines a sector number from the address data (ST24) and calculates the seek distance for the light beam of the optical pickup 42 on the basis of the determined sector number and the target track (ST25).

If NO in step ST23, the CPU 65 determines a sector number as the address of the header field 2 from the playback signal from the data processing unit 46 (ST26) and calculates the seek distance of the optical pickup 42 on the basis of the determined sector number and the target track number to be accessed (ST27).

After the seek distance is calculated in step ST25 or ST27, the CPU 65 determines whether the calculated seek distance falls within the fine access range (ST28). If NO in step ST28, the CPU 65 instructs the servo seek control unit 55 to perform a rough access (rough seek) to the target track (ST29), and the flow returns to step ST23.

On the basis of this instruction, the servo seek control unit 55 outputs an access signal to the driver 57, so that a bias signal from the driver 57 is supplied to the feed motor 51 to move the optical pickup 42 toward the target track.

In the seek across zones, the spindle motor driver 58 is controlled by a control signal from the data processing unit 46. The spindle motor 50 is biased and its rotation is controlled to a predetermined speed of rotation corresponding to the target zone.

If YES in step ST28, the CPU 65 determines whether the seek has reached the target position (ST30). If YES in step ST30, the seek processing is ended. If NO in step ST30, the CPU 65 instructs the servo seek control unit 55 to perform a fine access (fine seek) to the target track (ST31), and the flow returns to step ST23.

When the servo seek control unit 55 outputs an access signal to the driver 57 on the basis of this instruction, the objective lens 43 is moved toward the target track by the driver 57.

The CPU 65 calculates the access distance from the current position and requested position and repeatedly outputs an instruction to the servo seek control unit 55 until the seek reaches a position before the target sector, which is suitable for the access.

As described above, in an optical disk having spiral grooves and lands, data is recorded in the grooves in units of sectors, and address data such as sector numbers are recorded in advance in the lands adjacent to the grooves segmented into sectors, using pre-pit trains.

With this structure, tracking error can be quickly determined in recording data on an optical disk whose format efficiency is as high as in a read-only disk.

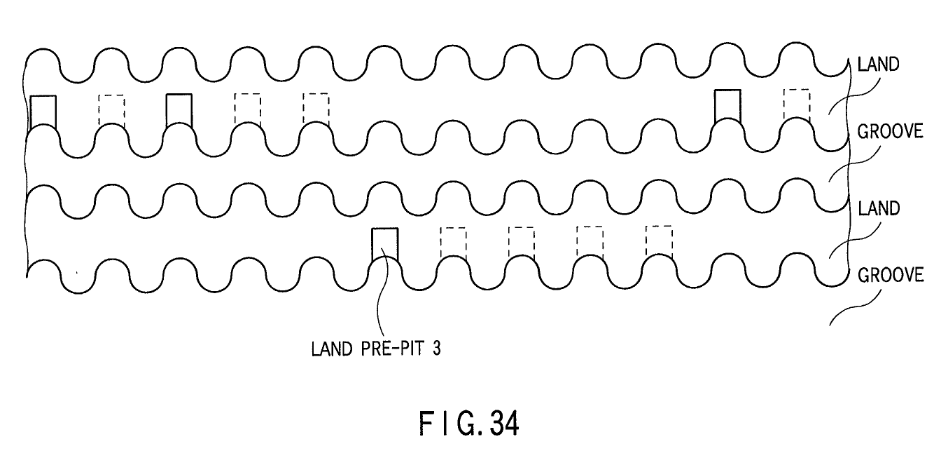

FIG. 34 is a view showing the second embodiment of the present invention.

In the second embodiment, a land pre-pit 3 is formed at a position synchronized with a convex portion of a wobbled groove, where data is recorded, as a rectangular pit notched to the middle of a land along a direction perpendicular to the radial direction of the disk (wobble period).

Although a land pre-pit signal must be substantially separated from a recording mark in a groove, crosstalk occurs depending on the formation condition of the land pre-pit 3. The crosstalk is conventionally reduced by controlling the size or depth of the land pre-pit 3. In the second embodiment, the land pre-pit 3 is formed near the groove, and the crosstalk amount is controlled by the degree of proximity.

As in the first embodiment, tracking error can be detected using a land pre-pit signal by the land pre-pit 3.

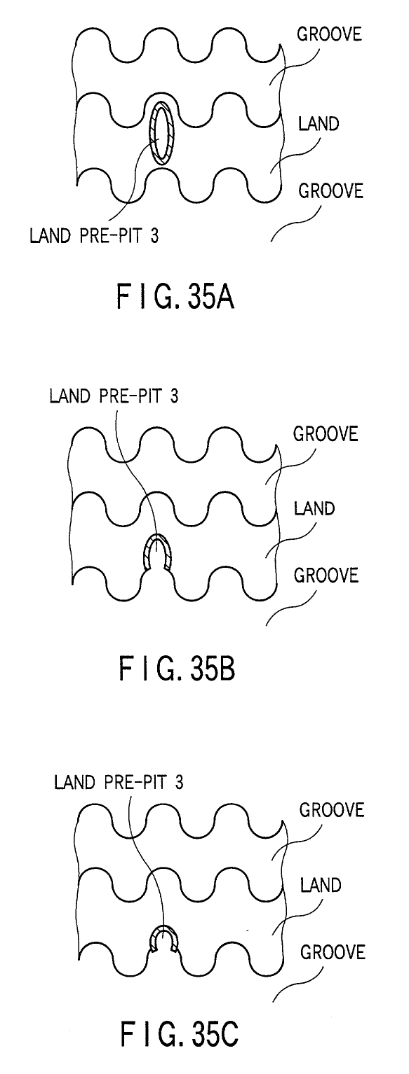

The land pre-pit 3 shown in FIG. 34 is rectangular. FIGS. 35A to 35C show land pre-pits 3 having a circular or elliptical shape. FIGS. 35A to 35C are views schematically showing the positional relationship between the land, the grooves, and the land pre-pit 3. Since the scale size ratio in the circumferential direction does not match that in the radial direction, the relationship of the major and minor diameters of the ellipse is not always the same as that in the illustrations.

Referring to FIG. 35A, the central position of the land pre-pit 3 is equidistant from the ends of grooves on both sides so that the grooves and the outer periphery of the pit do not overlap. Referring to FIG. 35B, the land pre-pit 3 overlaps one groove. The crosstalk amount is controlled by the degree of proximity. Referring to FIG. 35C, most part of the land pre-pit 3 overlaps a groove to further reduce the crosstalk.

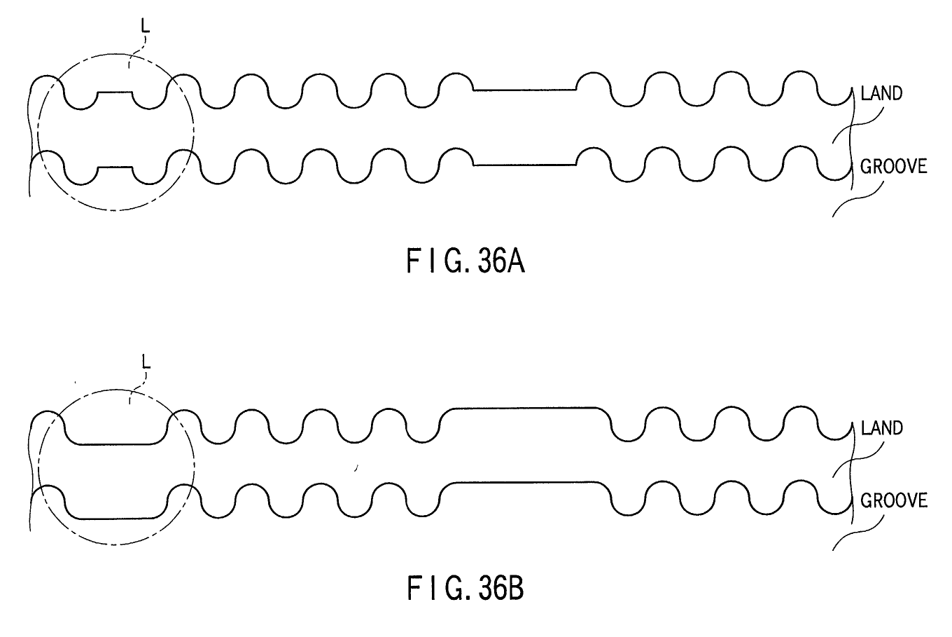

FIGS. 36A and 36B show the third embodiment of the present invention. In the third embodiment, the same function as in the first embodiment in which track data is recorded using the land pre-pit 3 is implemented by partially stopping wobbling in wobbled grooves.

A signal detection circuit 70 for detecting the partial stop of wobbling in wobbled grooves, which replaces the above-described land pre-pit signal detection circuit 4, will be described.

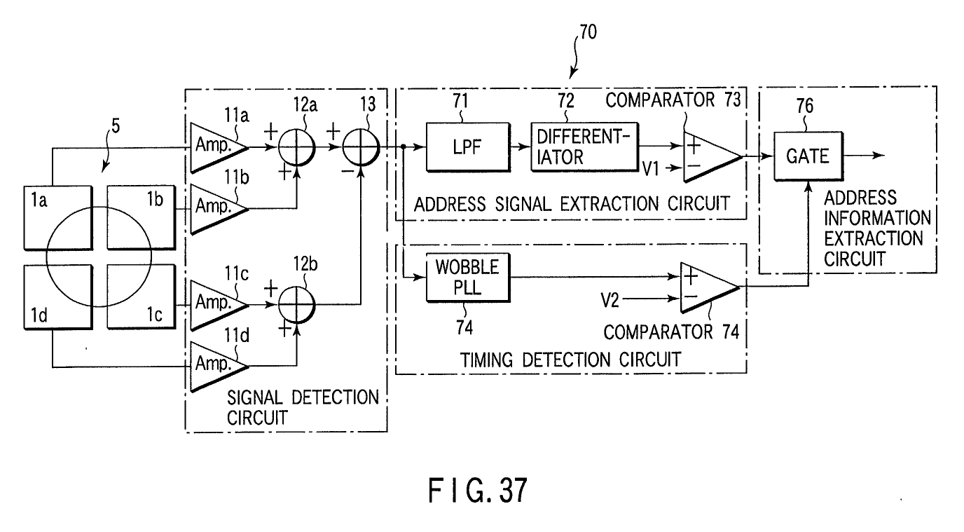

As shown in FIG. 37, the signal detection circuit 70 comprises a signal detection circuit formed from amplifiers 11a, 11b, 11c, and 11d for amplifying the detection signals (Ia, Ib, Ic, and Id) from a photodetector 5, an adder 12a for adding the signals from the amplifiers 11a and 11b, an adder 12b for adding the signals from the amplifiers 11c and 11d, and a subtractor 13 for subtracting the signal from the adder 12b from the signal from the adder 12a, an address signal extraction circuit formed from a low-pass filter (LPF) 71 for extracting a low-frequency signal component from the subtractor 13, a differentiator 72 for differentiating the output from the low-pass filter 71, and a comparator 73 for comparing the output from the differentiator 72 with a threshold value V1, a timing detection circuit formed from a wobble PLL 74 for generating a wobble clock synchronized with a wobble from the signal from the subtractor 13, and a comparator 75 for comparing the signal from the wobble PLL 74 with a threshold value V2 and outputting a gate open signal corresponding to a convex portion of a wobble, and an address information extraction circuit formed from a gate 76 for outputting a signal corresponding to an interrupt in wobble in accordance with the signal corresponding to a convex portion of a wobble, which is output from the comparator 73, and the gate open signal from the comparator 75.

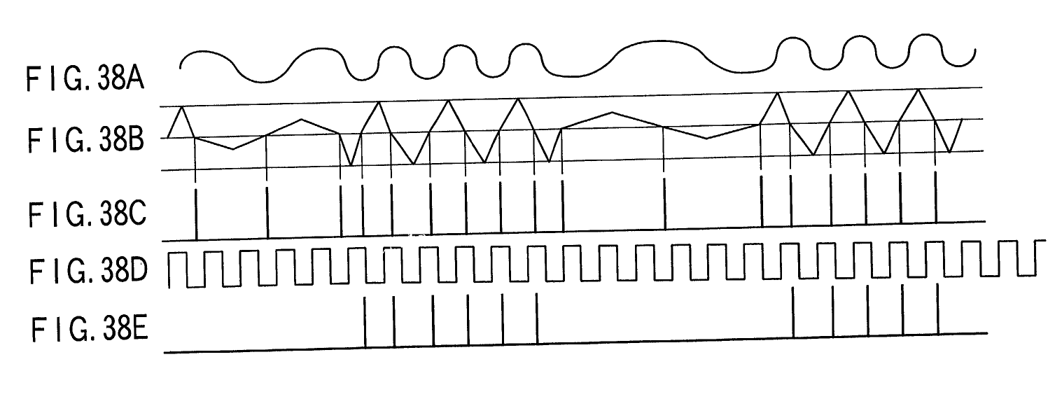

When the grooves shown in FIG. 36A or 36B are scanned with a light beam L, a signal shown in FIG. 38A is output from the subtractor 13. That is, when a signal [(Ia+Ib)−(Ic+Id)] is observed using the detection signals (Ia, Ib, Ic, and Id) from the photodetector 5, the waveform shown in FIG. 38A is observed.

When only a low-frequency component is extracted by the LPF 71 from the signal from the subtractor 13, and the extracted signal component is differentiated by the differentiator 72, a differential signal as shown in FIG. 38B is obtained. When a signal as shown in FIG. 38C, which is obtained by comparing the differential signal with the threshold value V1, is gated by a signal as shown in FIG. 38D, which is synchronized with a wobble clock from the wobble PLL 74, the gate 76 outputs a signal as shown in FIG. 38E, which is based on the wobble stop position.

When 1-bit information is recorded at one wobble amplitude stop position, the recordable information amount can be increased. To improve the reliability, a code may be formed by a plurality of wobble amplitude stop positions to represent 1-bit information. The number of wobble amplitude stop positions that form a code may be equal to the number of wobble amplitude stop positions that can be inserted into one sync frame.

Even in the embodiment in which track number information is recorded using a wobbling stop position of a wobbled groove, as in the embodiment using lands/grooves, when a code is formed from a plurality of wobble amplitude stoppable positions, the coding scheme is not limited to a scheme of mapping 1-bit data to a plurality of bits of wobble amplitude stoppable positions. Instead, a more general (n,m) modulation scheme of converting n-bit information into m bit sequences can also be used without any problem.

FIG. 39 is a view showing the fourth embodiment of the present invention.

In the above-described first embodiment, in an optical disk having spiral grooves and lands, data is recorded in the grooves in units of sectors, and address data such as sector numbers are recorded in advance in the lands adjacent to the grooves segmented into sectors, using pre-pit trains. In the fourth embodiment, in an optical disk having spiral grooves and lands, data is recorded in the lands in units of sectors, and address data such as sector numbers are recorded in advance in the grooves adjacent to the lands segmented into sectors, using groove interrupts.

In the fourth embodiment, as shown in FIG. 39, pre-pit headers and marks are recorded at land portions. In addition, pre-grooves each having a V-shaped section in the direction of depth are formed between recording tracks. The depth of a pre-pit header is

¼×λ/n

where

λ: wavelength

n: substrate refractive index

The depth of a pre-groove is given by

¼×λ/n

where

λ: wavelength

n: substrate refractive index

A pre-groove wobbles and has discontinuous portions, as shown in FIG. 39. Tracking error is detected using a signal obtained from such a discontinuous portion, as in the first embodiment.

FIG. 40 is a view showing the fifth embodiment of the present invention.

The fifth embodiment employs a scheme of recording data at both land portions and groove portions. In this case, as the structure of an optical disk 1, lands and grooves serving as user data areas where data is recorded are formed on every other round. A pre-pit train as a header field is formed at the switching position of one round. The header field has a groove header area and a land header area. The groove header area may be formed at a position opposing a groove while a land header area may be formed at a position opposing a land while being separated from the groove header area by one track pitch. Alternatively, from this state, the groove and land header areas are made close to each other by a ½ track pitch.

As the boundaries between the land portions and the groove portions (boundaries in the radial direction of the optical disk 1), linear boundaries and boundaries with projecting portions alternately appear. Tracking error is detected using a signal obtained from a projecting portion.

A signal detection circuit 80 for detecting a signal for a projection portion (notch in a land) at the boundary between a land portion and a groove portion, which replaces the above-described land pre-pit signal detection circuit 4, will be described.

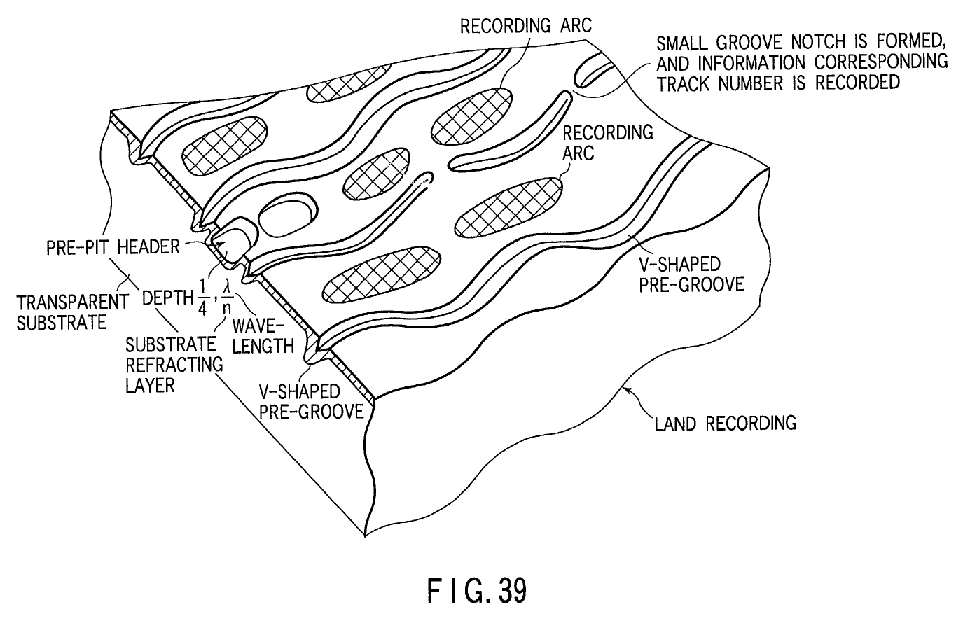

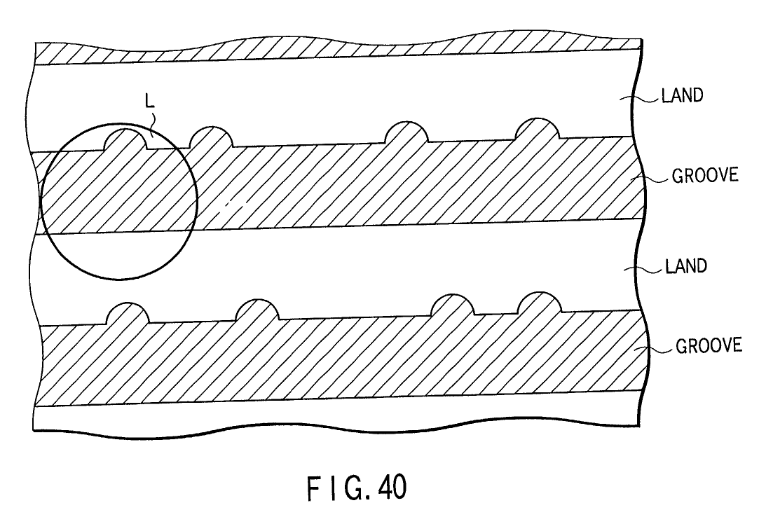

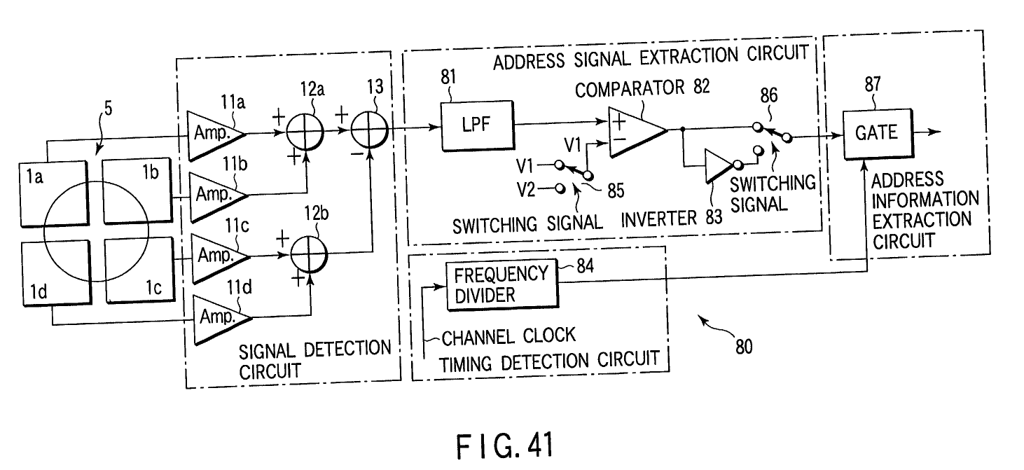

As shown in FIG. 41, the signal detection circuit 80 comprises a signal detection circuit formed from amplifiers 11a, 11b, 11c, and lid for amplifying the detection signals (Ia, Ib, Ic, and Id) from a photodetector 5, an adder 12a for adding the signals from the amplifiers 11a and 11b, an adder 12b for adding the signals from the amplifiers 11c and 11d, and a subtractor 13 for subtracting the signal from the adder 12b from the signal from the adder 12a, an address signal extraction circuit formed from a low-pass filter (LPF) 81 for extracting a low-frequency signal component from the subtractor 13, a comparator 82 for comparing the output from the low-pass filter 81 with a threshold value V1 or V2, an inverter 83 for inverting the output from the comparator 82, and changeover switches 85 and 86 which are switched in accordance with the polarities of lands and grooves, a timing detection circuit formed from a frequency divider 84 for frequency-dividing a channel clock having a predetermined frequency, which is output from a playback PLL circuit (not shown), and an address information extraction circuit formed from a gate 87 for outputting a signal corresponding to a notch in a land in accordance with the signal corresponding to the notch portion in the land, which is output from the changeover switch 86, and the gate open signal from the frequency divider 84.

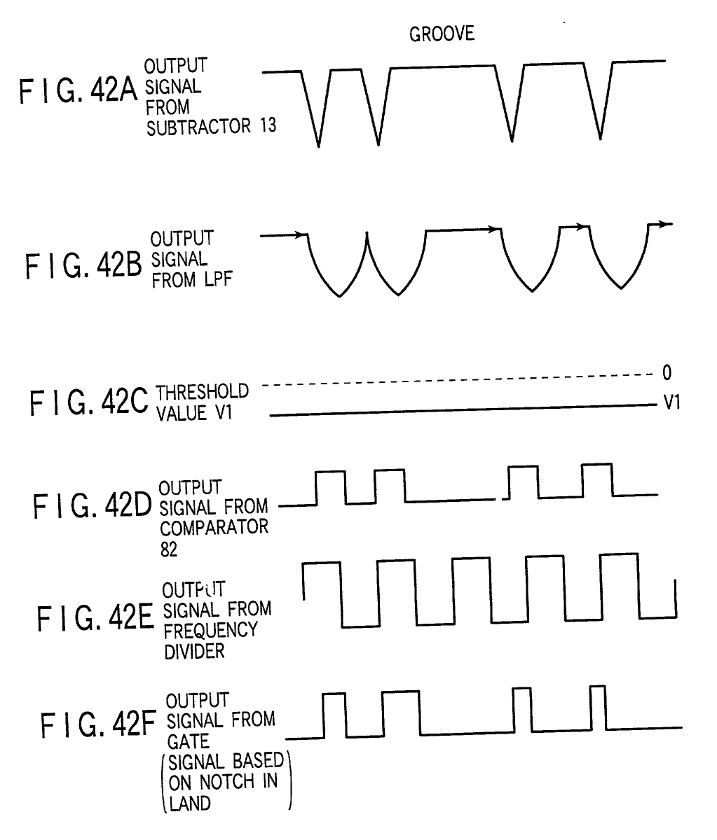

When the groove shown in FIG. 40A is scanned with a light beam L, the changeover switch 85 is set to the threshold value V1 side, and the changeover switch 86 is set to the comparator 82 side by switching signals from a CPU, a signal shown in FIG. 42A is output from the subtractor 13. That is, when a signal [(Ia+Ib)−(Ic+Id)] is observed using the detection signals (Ia, Ib, Ic, and Id) from the photodetector 5, the waveform shown in FIG. 42A is observed.

When only a low-frequency component is extracted by the LPF 81 from the signal from the subtractor 13, a signal as shown in FIG. 42B is obtained. When a signal as shown in FIG. 42D, which is obtained by comparing the signal with the threshold value V1 as shown in FIG. 42C, is gated by a signal as shown in FIG. 42E, which is output from the frequency divider 84, the gate 87 outputs a signal as shown in FIG. 42F, which is based on the notch in the land (projecting portion at the boundary between the land portion and the groove portion).

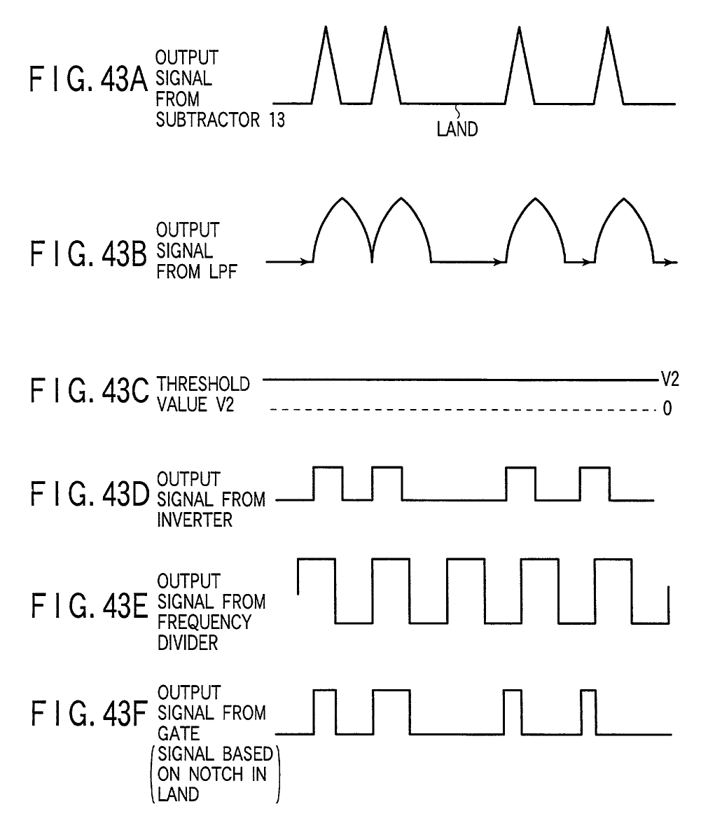

When the groove shown in FIG. 40A is scanned with the light beam L, the changeover switch 85 is set to the threshold value V2 side, and the changeover switch 86 is set to the inverter 83 side by switching signals from the CPU, a signal shown in FIG. 43A is output from the subtractor 13. That is, when a signal [(Ia+Ib)−(Ic+Id)] is observed using the detection signals (Ia, Ib, Ic, and Id) from the photodetector 5, the waveform shown in FIG. 43A is observed.

When only a low-frequency component is extracted by the LPF 81 from the signal from the subtractor 13, a signal as shown in FIG. 43B is obtained. When a signal as shown in FIG. 43D, which is obtained by comparing the signal with the threshold value V2 as shown in FIG. 43C, is gated by a signal as shown in FIG. 43E, which is output from the frequency divider 84, the gate 87 outputs a signal as shown in FIG. 43F, which is based on the notch in the land (projecting portion at the boundary between the land portion and the groove portion).

In the fifth embodiment, a self sync pattern must be prepared because no signal for synchronizing the position is used, unlike the case using a wobbled groove. That is, a frequency lead-in pattern and a pattern for detecting data delimitation must be recorded before a pattern for recording a track position. The frequency divider shown in FIG. 41 is controlled by a control means (CPU) (not shown) to lead in the phase at the position of the frequency lead-in pattern and lock the phase at a data portion where a track number is recorded.

One-bit information is recorded at one land/groove boundary projecting portion. To improve the reliability, a code may be formed by a plurality of land/groove boundary projecting portions to represent 1-bit information, as in the first embodiment. Not only the coding scheme of mapping 1-bit data to a plurality of bits of land pre-pits but also an (n,m) modulation scheme of converting n-bit information into m bit sequences can be used without any problem.

In the fifth embodiment, a land portion and groove portion on both sides of a boundary having a projecting portion share track position information by the same land/groove boundary projecting portion. That is, since a piece of track position information is constituted by two tracks, an absolute track position is acquired by combining track position information represented by the same land/groove boundary projecting portion and information representing whether the current position is the track at the land portion or the track at the groove portion.

In the above description, for the sake of simplicity, when a code is formed by a plurality of land pre-pits, a coding scheme of mapping 1-bit data into a plurality of bits of land pre-pits is employed. However, a more general (n,m) modulation scheme of converting n-bit information into m bit sequences can also be used without any problem.

When a tracking error is preferably detected as soon as possible, the number of boundary projecting portions that must be read to detect a tracking error is preferably as small as possible. However, this makes the recordable number of track numbers small. In such a case, instead of recording all track numbers on the disk by absolute values, the tracks may be divided into several zones, and relative positions in each zone may be recorded, as shown in FIG. 6 of the first embodiment.

The minimum data rewrite unit is a sector. Hence, when the number of boundary projecting portions which must be read to detect a tracking error is smaller than the number of boundary projecting portions which can be recorded in one sector, the range of erase error due to a tracking error can be minimized. In addition, when the number of boundary projecting portions which must be read to detect a tracking error is reduced to an integer fraction of the number of boundary projecting portions which can be recorded in one sector, and the start position of the sequence of the boundary projecting portions which must be read to detect a tracking error is aligned with the start position of the sector, the detection efficiency improves.

As described above, even when the pre-pit headers are not prepared in units of minimum recording units, jump to another track can be quickly detected during a data write. For this reason, an optical disk which can ensure high reliability while increasing the format efficiency as high as in a read-only disk can be provided.

In the optical disk of the present invention, address information on a track is recorded at a portion different from a track on which information is recorded.

In the optical disk of the present invention, track address information is recorded at least for each minimum recordable unit (sector).

In the optical disk of the present invention, data is recorded in accordance with a data format having a header field prepared independently of user data to access an area on the optical disk, at which an address is recorded, and an area where the user data is recorded. Even in a user data area between the headers, address information is recorded along a track on which data is recorded.

In the optical disk of the present invention, address information recorded along a track on which data is recorded is information for identifying a track in one of a plurality of zones defined in the radial direction.

In the optical disk of the present invention, a track on which user data is recorded is a wobbled groove, and address information along the data track is recorded by a pre-pit formed at a land portion between grooves.

In the optical disk of the present invention, a track on which user data is recorded is a wobbled groove, address information recordable positions along the data track are classified into two groups, i.e., even- and odd-numbered positions, and pieces of adjacent address information are recorded at positions of different groups.

In the optical disk of the present invention, a track on which user data is recorded is a wobbled groove, address information recordable positions along the data track are classified into two groups, i.e., even- and odd-numbered positions, and normally, address information is recorded at an even- or odd-numbered position. However, if the recording positions of adjacent address information are aligned in the radial direction, one of the adjacent pre-pits is recorded at a position different from the normal recording position.

In the optical disk of the present invention, a track on which user data is recorded is a wobbled groove, and address information along the data track is recorded by a modulated code.

In the optical disk of the present invention, a track on which user data is recorded is a wobbled groove, and address information along the data track is recorded in each minimum recordable unit multiple times (repeatedly a plurality of number of times).

In the optical disk of the present invention, a track on which user data is recorded is a wobbled groove, and when the minimum write unit of user data is divided at a header field at which an address is recorded, address information along the data track is switched before and after the header field.

In the optical disk of the present invention, a track on which user data is recorded is a wobbled groove, and when the minimum write unit of user data is divided at a header field at which an address is recorded, address information along the data track is switched from the start portion of the divided user data.

In the optical disk of the present invention, a track on which user data is recorded is a wobbled groove, and when the minimum write unit of user data is divided at a header field at which an address is recorded, address information along the data track is recorded only at the succeeding portion of the divided user data.

In the optical disk of the present invention, a track on which user data is recorded is a wobbled groove, and when the minimum write unit of user data is divided at a header field at which an address is recorded, recording of address information along the data track is stopped at the divided user data portion.

In the optical disk of the present invention, a track on which user data is recorded is a wobbled groove, address information along the data track is recorded by a pre-pit formed at a land portion between grooves, and the pre-pit formed at the land portion is laid out radially asymmetrically with respect to a straight line that connects equidistant points of the grooves on both sides from the center.

In the optical disk of the present invention, a track on which user data is recorded is a wobbled groove, address information along the data track is recorded by a pre-pit formed at a land portion between grooves, the pre-pit formed at the land portion has a circular or elliptical shape, and part of the pre-pit at the land portion overlaps a groove in terms of position.

In the optical disk of the present invention, a track on which user data is recorded is a wobbled groove, and address information along the data track is recorded as information represented by a position at which the wobble partially stops.

In the optical disk of the present invention, a track on which user data is recorded is a wobbled groove, and address information along the data track is recorded as information represented by a position at which the wobble is partially interrupted.

In the optical disk of the present invention, user data is recorded at both a land portion and a groove portion, the land portion and groove portion have a linear boundary and a boundary having a projecting portion therebetween, these boundaries with different shapes are alternately formed, and address information along the data track is recorded as information represented by the position of the projecting portion of the boundary with the projecting portion.

In the optical disk of the present invention, a track address is read from address information recorded along a track on which user data is recorded on the optical disk, thereby detecting a tracking error. Additionally, upon detecting a tracking error during a data write operation, the write operation is interrupted.

In the optical disk of the present invention, a track address is read from address information recorded along a track on the optical disk, on which user data is recorded, and is used as position information for seek.

According to the above-described first embodiment, a pre-pit is formed in synchronism with a wobble period at a land portion between wobbled grooves in which data is recorded, and track number information is recorded at the land pre-pit portion. This track information is recorded at least once in the minimum write unit. For this reason, even when the pre-pit header is not prepared for each minimum write unit, a tracking error can be quickly detected in the write mode.

According to the above-described second embodiment, the land pre-pit of the first embodiment partially overlaps a groove.

According to the above-described third embodiment, the same function as in recording track information using a land pre-pit can be realized by partially stopping wobbling in a wobbled groove.

According to the above-described fourth embodiment, pre-pit headers and marks are recorded at land portions, and pre-grooves each having a V-shaped section in the direction of depth are formed between recording tracks. A pre-groove wobbles and partially has discontinuous portions. Tracking error is detected using a signal obtained from such a discontinuous portion.

According to the above-described fifth embodiment, in a scheme of recording data at both land portions and groove portions, linear boundaries and boundaries with projecting portions alternately appear. Tracking error is detected using a signal obtained from a projecting portion.

As has been described above, according to the present invention, by recording track information between data recording tracks, tracking error can be quickly detected even in the data write mode without reducing the format efficiency, and high reliability can be maintained.

The optical disk of the present invention has spiral or concentric tracks of grooves having recorded data and wobbled at a predetermined frequency and also has a plurality of sectors each formed from a recording area where data is recorded in a groove having a predetermined track length. Addresses representing positions on tracks are recorded by pre-pit trains at adjacent lands in units of sectors, and the position of each pre-pit opposes the position of a convex portion of the wobbled groove.

The optical disk of the present invention has spiral or concentric tracks of lands having recorded data wobbled at a predetermined frequency and also has a plurality of sectors each formed from a recording area where data is recorded in a land having a predetermined track length. Addresses representing positions on tracks are recorded by notches in adjacent grooves in units of sectors, and the position of each notch in a groove opposes the position of a convex portion of the wobble land.

The optical disk of the present invention has spiral or concentric tracks of grooves and lands having data recorded by recording pits and also has a plurality of sectors each formed from a recording area where data is recorded in a groove and land having a predetermined track length. Addresses representing positions on tracks are recorded by notches on the land side of the boundary between adjacent groove and land in units of sectors. The notches formed on the land side do not affect the recording pits recorded in the lands.

The optical disk apparatus of the present invention is an apparatus for recording data on an optical disk which has spiral or concentric grooves and lands, the grooves as recording tracks having recorded data, and also has a plurality of sectors each formed from a recording area where data is recorded in a groove having a predetermined track length and in which addresses representing positions on tracks are recorded by pre-pit trains at adjacent lands in units of sectors, and the apparatus comprises a focus means for focusing light onto a groove on the optical disk, a detection means for detecting the light from the optical disk, extraction means for, when data is recorded by focusing the light onto a groove on a predetermined track of the optical disk by the focus means, extracting the signal of a pre-pit train recorded in a land adjacent to the light focusing position on the basis of a detection signal from the detection means, a first determination means for determining an address representing a position on the track on the basis of the signal of the pre-pit train extracted by the extraction means, and a second determination means for determining a tracking error on the basis of whether the address determined by the first determination means matches an address at which the data is recorded.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical disk further comprising tracks which are formed into a spiral or concentric shape and have recorded data,
wherein each of the tracks is formed from a data recording area and a header area where data cannot be directly recorded and has an address recorded in advance at least at a portion in the data recording area.

2. A disk according to claim 1, wherein
the data recording area has at least a land and a groove, and
address information is provided in a state wherein the land is partially notched in a direction perpendicular to a direction of the track.

3. A disk according to claim 1, wherein
at least one header area is provided for each round of the tracks, and
an address representing a position on the track is recorded in the header area by a pre-pit train.

4. An optical disk further comprising tracks which are formed into a spiral or concentric shape and have data recorded by a recording mark,
wherein an address representing a position on the track is recorded by a notch formed on a land side or groove side of a boundary between the adjacent groove and land.

5. A disk according to claim 4, wherein
at least one header area is provided for each round of the tracks, and
an address representing a position on the track is recorded in the header area by a pre-pit train.

6. An optical disk apparatus for recording data on an optical disk which has tracks formed into a spiral or concentric shape, each of the tracks being formed from a data recording area and a header area where data cannot be directly recorded and having an address recorded in advance at least at a portion in the data recording area, further comprising:
focus means for focusing light onto the track on the optical disk;
detection means for detecting the light from the optical disk;
extraction means for, when data is recorded by focusing the light onto a predetermined track on the optical disk by said focus means, extracting address information on the basis of a detection signal from said detection means; and
determination means for determining a tracking error on the basis of the address information extracted by said extraction means.

7. An optical disk tracking error determination method of recording data on an optical disk which has tracks formed into a spiral or concentric shape, each of the tracks being formed from a data recording area and a header area where data cannot be directly recorded and having an address recorded in advance at least at a portion in the data recording area, further comprising the steps of:
when data is recorded by focusing light onto a predetermined track on the optical disk, extracting address information of a focus position of the light on the basis of a detection signal from detection means; and
determining a tracking error on the basis of the extracted address information.
